(19) United States
(12) Patent Application Publication
(10) Pub. No.: US 2016/0048806 A1
(43) Pub. Date: Feb. 18, 2016

(54) COMPUTER-BASED PROJECT MANAGEMENT METHODS AND SYSTEMS

(71) Applicant: JOBFILEZ, INC., Long Beach, CA (US)

(72) Inventors: Joseph William Epson, Long Beach, CA (US); Mario Diaz, Corona, CA (US)

(21) Appl. No.: 14/462,332

(22) Filed: Aug. 18, 2014

(51) Int. Cl. G06Q 10/10

(52) U.S. Cl. CPC G06Q 10/103

(57) ABSTRACT

A computer-based method and platform that acts like a database that allows users to store contact information, set up jobs, and store all information related to a specific job, including, but not limited to: photos, videos, documents, reports, and forms. The platform generally allows users to set up projects with project icons, upload information and files in an organized manner, and then allow other users who have been granted access to the projects to quickly view the uploaded files.

### FIELD

The present disclosure generally relates to computer-based project management methods and systems. More particularly, the disclosure generally relates to a computer-based method for setting up, storing, and sharing information, documents, videos, and reports. The methods and systems may provide a software-based platform that functions like a database and allows users to store contact information, set up jobs, and store all information related to that specific job, including, but not limited to: photos, videos, documents, reports, and forms. The platform may be easy to use and may allow the user to create, move, and arrange icons. These icons generally permit users to quickly access specific jobs or job files to quickly and easily access all photos, videos, reports, notes, and the like.

### BACKGROUND

Businesses generally expend significant resources and time in monitoring, tracking, setting up, and organizing various jobs, projects, and/or tasks. Communication difficulties and a lack of an effective and organized way to share information typically leads to managers wasting time and money wondering about what workers are doing on a specific job or project.

Although there are numerous enterprise-, server-, and/or cloud-based programs that allow users to share information and files, these files are generally difficult to load—loaded without any set icon-based organization—and are usually difficult to securely share with those outside of the company.

Thus, there is a need in the art for computer-based project management methods and systems that can be loaded quickly and then immediately accessed by others, all in the framework of an organized and icon-based graphical user interface.

### SUMMARY

To minimize the limitations in the prior art, and to minimize other limitations that will become apparent upon reading and understanding the present specification, the present invention discloses new and useful computer-based project management methods and systems.

The computer-based method may allow users to set up, store, and share information, documents, videos, and reports.

The methods and systems may provide a software-based platform that acts like a database that allows users to store contact information, set up jobs, and store all information related to that specific job, including but not limited to: photos; videos; documents; reports; and forms. The platform may allow users to create, move, and arrange icons, within a graphical user interface. This allows multiple users to quickly access specific jobs, projects or tasks, and any of the files for that job, to quickly understand what is happing with that specific job. The software platform may be used by companies that have many different users. Each user of each company may sign in to the system and be given access to one or more projects that are related to the company. The customers of the company may also be given access to sign in and view projects, but that access may be limited to projects related to that customer.

Company administrator users may start the project management process by first determining who will be able to access that project and what type of access each person will have. For example, a company user may be able to add, view, and delete files, whereas another company user may be restricted to merely viewing the files.

Once a project is set up, a set of icons may be selected and used as database locations to store some or all of the files, photos, and forms.

Once logged in, a user can begin adding contacts and then the jobs that the user wants. Once a job is added, a set of icons is used to store all of that particular job's files in order to allow users to quickly access and use all photos, videos, documents, reports and notes created by any and all other users, with respect to that particular job.

The invention may allow project managers to easily see what is happening on the jobs that are uploaded to the system. The videos and photos may be well organized, quickly uploaded, and immediately accessible from anywhere and through any electronic data processing device or computer.

The methods and systems may save project managers, employees, users, and customers a significant amount to time. The users may view the uploads before telephone conferences so that no time need be wasted with updates that are provided by photos, videos, and reports.

The methods and systems may be comprised of setting up the project, entering names and contacts of those users and customers who will have access, entering job information, and selecting the desired icons that will be used to group and store all of that project's work orders, reports, photos, videos, documents, etc. In this manner, any and all projects for that specific customer can be easily and quickly found by the users, with minimal interface and time.

One embodiment may be a project management method, the computer-implemented steps comprising: providing a project management software platform running on a server; wherein the project management software platform is accessible by one or more electronic data processing units; wherein the one or more electronic data processing units each have at least one display and are configured to access the project management software platform; wherein the project management software platform comprises a plurality of project icons; wherein the plurality of project icons are configured for linking a plurality of database locations for storing one or more files and a plurality of text information associated with one or more projects; allowing access on an administrative basis to the project management software platform via at least one of the one or more electronic data processing units in order to set up one or more projects; storing a plurality of user accounts on the project management software platform; allowing a user to set up the one or more projects via the project management software platform; wherein the setting-up step comprises the steps of: receiving which of the plurality of user accounts will be configured to access each of the one or more projects being set up; and receiving one or more of the plurality of project icons to be associated with each of the one or more projects; receiving by the project management software platform of a user login information through at least one of the one or more electronic data processing units; presenting to the logged-in user the projects to which the logged-in user has access; allowing the logged-in user to upload the one or more files associated with the one or more projects to at least one of the plurality of project icons within at least one of the one or more projects; wherein the one or more uploaded files are organized within the plurality of project icons such that the project management software platform allows at least one second user to find and view the one or more uploaded files with a minimal waste of time; and allowing at least one second user to view the one or more uploaded files on the at least one display with minimal time wasted in finding the one or more uploaded files. The setting-up steps may further comprise the step of: determining what type of access each of the selected user accounts has. The project management software platform may be accessible through the Internet. The project management software platform may collect a username and a password of the user and the at least one second user. The plurality of project icons may be selected from the group of project icons consisting of: media; field reports; work orders; office documents; notes; reports; costs; billing; subcontractor; and daily logs. The one or more uploaded files may be comprised of video and photo files that are displayed as thumbnails within the plurality of project icons. The method according may further comprise the steps of: wherein one or more of the plurality of project icons may be configured to accept entry of a plurality of text information; receiving a plurality of text information within at least one of the plurality of project icons. The plurality of project icons may be comprised of a visual indicator which is configured to notify that at least one of the one or more files have been uploaded. The plurality of project icons may comprises a visual indicator which is configured to notify that text information has been entered with at least one of the plurality of project icons. The project management software platform may be configured to organize and track: scheduling; purchase orders; human resources; and assets.

Another embodiment may be a project management method, the computer-implemented steps comprising: providing a project management software platform running on a server; wherein the project management software platform is accessible by one or more electronic data processing units; wherein the one or more electronic data processing units each have at least one display and are configured to access the project management software platform; wherein the project management software platform comprises a plurality of project icons; wherein the plurality of project icons configured for linking a plurality of database locations for storing one or more files associated with one or more projects; allowing access on an administrative basis to the project management software platform via at least one of the one or more electronic data processing units in order to set up one or more projects; allowing a user to set-up the one or more projects via the project management software platform; wherein the setting-up step comprises the steps of: receiving which of a plurality of users may access each of the one or more projects; storing what type of access that each of the selected users may have; and receiving one or more of the plurality of project icons to be associated with each of the one or more projects; receiving by the project management software platform a user login information through at least one of the one or more electronic data processing units; presenting to the logged-in user the projects to which the logged-in user has access; receiving by the plurality of project icons within at least one of the one or more projects the one or more files associated with the one or more projects; wherein the one or more uploaded files are organized within the plurality of project icons such that the project management software platform allows at least one second user to find and view the one or more uploaded files with a minimal waste of time; and viewing by at least one second user the one or more uploaded files on the at least one display with minimal time wasted in finding the one or more uploaded files. The project management software platform may be accessible through the Internet. The project management software platform may collect a username and a password of the user. The plurality of project icons may be selected from the group of project icons consisting of: media; field reports; work orders; office documents; notes; reports; costs; billing; subcontractor; and daily logs. The one or more uploaded files may be comprised of video and photo files that are displayed as thumbnails within the plurality of project icons. The method may further comprise the steps of: wherein one or more of the plurality of project icons may be configured to accept entry of a plurality of text information; receiving a plurality of text information within at least one of the plurality of project icons. The plurality of project icons may be comprised of a visual indicator which is configured to notify that at least one of the one or more files have been uploaded. The plurality of project icons may be comprised of a visual indicator which is configured to notify that text information has been entered with at least one of the plurality of project icons. The project management software platform may be configured to organize and track: scheduling; purchase orders; human resources; and assets.

Another embodiment may be a project management method, the computer-implemented steps comprising: providing a project management software platform running on a server; providing one or more electronic data processing units; wherein the one or more electronic data processing units each have at least one display and can access the project management software platform; wherein the project management software platform is comprised of a plurality of project icons; wherein the plurality of project icons are used as a plurality of database locations to store one or more files associated with one or more projects; allowing access on an administrative basis to the project management software platform via at least one of the one or more electronic data processing units in order to set up one or more projects; allowing a user to set-up the one or more projects via the project management software platform; wherein the setting-up step comprises the steps of: receiving which of a plurality of users may access each of the one or more projects; storing what type of access each of the selected users may have; and receiving one or more of the plurality of project icons to be associated with each of the one or more projects; receiving by the project management software platform of a user login information through at least one of the one or more electronic data processing units; presenting to the logged-in user the projects to which the logged-in user has access; receiving by the plurality of project icons within at least one of the one or more projects the one or more files associated with the one or more projects; wherein the one or more uploaded files are organized within the plurality of project icons such that the project management software platform allows at least one second user to find and view the one or more uploaded files with a minimal waste of time; viewing by at least one second user the one or more uploaded files on the at least one display with minimal time wasted in finding the one or more uploaded files; wherein the project management software platform is accessible through the Internet; wherein the the project management software platform collects username and a password of the user; wherein the plurality of project icons are selected from the group of project icons consisting of: media; field reports; work orders; office documents; notes; reports; costs; billing; subcontractor; and daily logs; wherein the one or more uploaded files are comprised of video and photo files that are displayed as thumbnails within the plurality of project icons; wherein one or more of the plurality of project icons are configured to accept entry of a plurality of text information; receiving a plurality of text information within at least one of the plurality of project icons; wherein the plurality of project icons are comprised of a visual indicator which is configured to notify that at least one of the one or more files have been uploaded; wherein the visual indicator is configured to notify that text information has been entered with at least one of the plurality of project icons; and wherein the project management software platform is configured to organize and track: scheduling; purchase orders; human resources; and assets.

Another embodiment may be a project management method, the computer-implemented steps comprising: providing a project management software platform running on a server; providing one or more electronic data processing units; wherein the one or more electronic data processing units each have at least one display and are configured to access the project management software platform; wherein the project management software platform is comprised of a plurality of project icons; wherein the plurality of project icons are used as a plurality of database locations to store one or more files and a plurality of text information associated with one or more projects; accessing on an administrative basis the project management software platform via at least one of the one or more electronic data processing units in order to set up one or more projects; creating a plurality of user accounts on the project management software platform; setting up the one or more projects via the project management software platform; wherein the setting-up step comprises the steps of: selecting which of the plurality of user accounts will be configured to access each of the one or more projects being set up; and selecting one or more of the plurality of project icons to be associated with each of the one or more projects; accessing by a user the project management software platform via a user login through at least one of the one or more electronic data processing units; presenting to the logged-in user the projects to which the logged-in user has access; uploading by the user the one or more files associated with the one or more projects to at least one of the plurality of project icons within at least one of the one or more projects; wherein the one or more uploaded files are organized within the plurality of project icons such that at least one second user can find and view the one or more uploaded files with a minimal waste of time; and viewing by at least one second user the one or more uploaded files on the at least one display with minimal time wasted in finding the one or more uploaded files. The setting-up steps may further comprise the step of: determining what type of access each of the selected user accounts has. The user and the second user may access the project management software platform through the Internet. The user and the second user may be assigned a username and a password to be used to access the project management software platform. The plurality of project icons may be selected from the group of project icons consisting of: media; field reports; work orders; office documents; notes; reports; costs; billing; subcontractor; and daily logs. The uploaded files may be comprised of video and photo files that are displayed as thumbnails within the project icons. The plurality of project icons may be configured to accept entry of a plurality of text information and the steps of the method may include entering a plurality of text information within at least one of the plurality of project icons. The plurality of project icons may be comprised of a visual indicator that informs the at least one second user that at least one of the one or more files have been uploaded. The plurality of project icons may be comprised of a visual indicator that informs the at least one second user that text information has been entered with at least one of the plurality of project icons. The project management software platform may also be configured to organize and track: scheduling; purchase orders; human resources; and assets.

Another embodiment of the invention may be a project management method, the computer-implemented steps comprising: providing a project management software platform running on a server; providing one or more electronic data processing units; wherein the one or more electronic data processing units each have at least one display and are configured to access the project management software platform; wherein the project management software platform is comprised of a plurality of project icons; wherein the plurality of project icons are used as a plurality of database locations to store one or more files associated with one or more projects; accessing on an administrative basis the project management software platform via at least one of the one or more electronic data processing units in order to set up one or more projects; setting up the one or more projects via the project management software platform; wherein the setting-up step comprises the steps of: selecting which of a plurality of users may access each of the one or more projects; determining what type of access each of the selected users may have; selecting one or more of the plurality of project icons to be associated with each of the one or more projects; accessing by a user the project management software platform via a user login through at least one of the one or more electronic data processing units; presenting to the logged-in user the projects to which the logged-in user has access; uploading by the user the one or more files associated with the one or more projects to at least one of the plurality of project icons within at least one of the one or more projects; wherein the one or more uploaded files are organized within the plurality of project icons such that at least one second user can find and view the one or more uploaded files with a minimal waste of time; viewing by at least one second user the one or more uploaded files on the at least one display with minimal time wasted in finding the one or more uploaded files. The user and the at least one second user may access the project management software platform through the Internet. The user and the at least one second user may be assigned a username and a password to be used to access the project management software platform. The plurality of project icons may be selected from the group of project icons consisting of: media; field reports; work orders; office documents; notes; reports; costs; billing; subcontractor; and/or daily logs. The one or more uploaded files may be comprised of video and photo files that are displayed as thumbnails within the plurality of project icons. The plurality of project icons may be configured to accept entry of a plurality of text information and the method may comprise: entering a plurality of text information within at least one of the plurality of project icons. The plurality of project icons may be comprised of a visual indicator that informs the at least one second user that at least one of the one or more files has been uploaded. The plurality of project icons may be comprised of a visual indicator that informs the at least one second user that text information has been entered with at least one of the plurality of project icons. The project management software platform may also be configured to organize and track: scheduling; purchase orders; human resources; and assets.

It is an object of the new method and system to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a flow chart of one embodiment of the project management method.

FIGS. 2A and 2B are a flow chart of another embodiment of the project management method.

FIG. 3 is a flow diagram of one embodiment of the system for the project management method.

FIG. 4 is a screen shot of one embodiment of the project management method and shows the login screen.

FIG. 5 is a screen shot of one embodiment of the project management method and shows the home screen.

FIG. 6 is a screen shot of one embodiment of the project management method and shows one embodiment of the jobs folder.

FIG. 7 is a screen shot of one embodiment of the project management method and shows another embodiment of the jobs folder.

FIG. 8 is a screen shot of one embodiment of the project management method and shows one embodiment of the media page of the jobs screen.

FIG. 9 is a screen shot of one embodiment of the project management method and shows the work orders screen of the jobs folder.

FIG. 10 is a screen shot of one embodiment of the project management method and shows the documents screen.

FIG. 11 is a screen shot of one embodiment of the project management method and shows the reports screen of the jobs folder.

FIG. 12 is a screen shot of one embodiment of the project management method and shows the costs screen of the jobs folder.

FIG. 13 is a screen shot of one embodiment of the project management method and shows the notes screen of the jobs folder.

FIG. 14 is a screen shot of one embodiment of the project management method and shows the job details screen.

FIG. 15 is a screen shot of one embodiment of the project management method and shows the billing screen.

FIG. 16 is a screen shot of one embodiment of the project management method and shows the schedule screen.

FIG. 17 is a screen shot of one embodiment of the project management method and shows the report main screen.

FIG. 18 is a screen shot of one embodiment of the project management method and shows the policies and procedures screen.

FIG. 19 is a screen shot of one embodiment of the project management method and shows the notices screen.

FIG. 20 is a screen shot of one embodiment of the project management method and shows the vehicles screen.

FIG. 21 is a screen shot of one embodiment of the project management method and shows the users screen.

FIG. 22 is a screen shot of one embodiment of the project management method and shows the contacts screen.

FIG. 23 is a screen shot of one embodiment of the project management method and shows the purchase orders screen.

FIG. 24 is a screen shot of another embodiment of the project management method and shows the home screen.

FIG. 25 is a screen shot of another embodiment of the project management method and shows the whiteboard screen.

FIG. 26 is a screen shot of another embodiment of the project management method and shows another embodiment of the jobs folder.

FIG. 27 is a screen shot of another embodiment of the project management method and shows another embodiment of the estimates screen of the jobs folder.

FIG. 28 is a screen shot of another embodiment of the project management method and shows the work orders screen of the jobs folder.

FIG. 29 is a screen shot of another embodiment of the project management method and shows the job details screen.

FIG. 30 is a screen shot of another embodiment of the project management method and shows the timecard screen.

FIG. 31 is a screen shot of another embodiment of the project management method and shows the contacts screen.

### DETAILED DESCRIPTION OF ILLUSTRATIVE EMBODIMENTS

In the following detailed description of various embodiments, numerous specific details are set forth in order to provide a thorough understanding of various aspects of the one or more embodiments. However, the embodiments may be practiced without some or all of these specific details. In other instances, well-known methods, procedures, and/or components have not been described in detail so as not to unnecessarily obscure aspects of the embodiments.

While multiple embodiments are disclosed, still other embodiments of the present disclosure will become apparent to those skilled in the art from the following detailed description, which shows and describes illustrative embodiments. As will be realized, the embodiments in this disclosure are capable of modifications in various obvious aspects, all without departing from the spirit and scope of the present disclosure. Accordingly, the graphs, figures, and the detailed descriptions thereof, are to be regarded as illustrative in nature and not restrictive. Also, the reference or non-reference to a particular embodiment shall not be interpreted to limit the scope of the invention.

Before the following embodiments are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It should be understood that some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set or distributed over different locations, including over different storage devices, and may exist, at least partially, merely as electronic signals on a system or network. The modules may be passive or active, including agents operable to perform desired functions.

### Definitions

In the following description, certain terminology is used to describe certain features of one or more embodiments. For example, as used herein, the terms “mobile computing device”, “device”, “computer”, “computing device”, “electronic data processing unit”, or “server” refers to any device that processes information with an integrated circuit chip, including without limitation, personal computers, mainframe computers, workstations, servers, desktop computers, portable computers, laptop computers, embedded computers, wireless devices including cellular phones, personal digital assistants, tablets, tablet computers, smartphones, portable game players, and hand-held computers.

As used herein, the term “Internet” generally refers to any collection of networks that utilizes standard protocols, whether Ethernet, Token ring, Wifi, asynchronous transfer mode (ATM), Fiber Distributed Data Interface (FDDI), code division multiple access (CDMA), global systems for mobile communications (GSM), long term evolution (LTE), or any combination thereof. The term “website” refers to any document written in a mark-up language including, but not limited to, hypertext mark-up language (HTML) or virtual reality modeling language (VRML), dynamic HTML, extended mark-up language (XML), wireless markup language (WML), or any other computer languages related thereto, as well as to any collection of such documents reachable through one specific Internet Protocol Address or at one specific World Wide Web site, or any document obtainable through any particular Uniform Resource Locator (URL).

As used herein, the terms “webpage”, “page”, “website”, or “site” generally refers to any of the various documents and resources on the World Wide Web, in HTML/XHTML format with hypertext links to enable navigation from one page or section to another, or similar such resources used on the Internet.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

The computer-based method proposed by the present invention is preferably a server application running on a server that allows a user to link a user account to the server application.

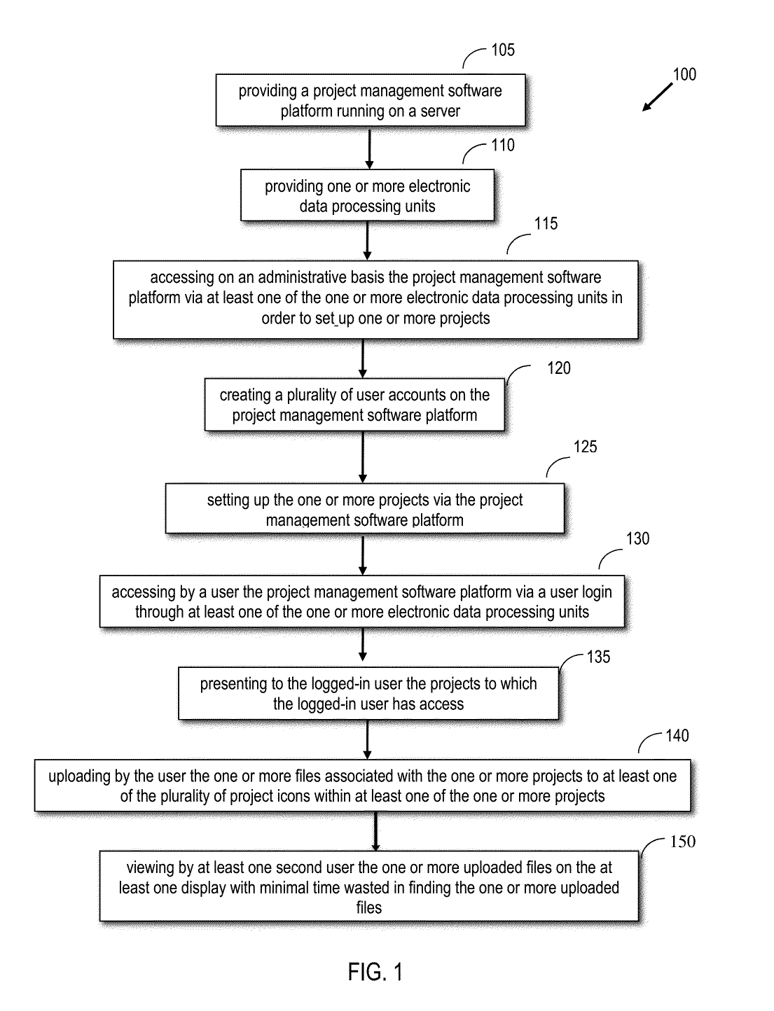

FIG. 1 is a flow chart of one embodiment of the project management method. As shown in FIG. 1, one embodiment of the method 100 may comprise the steps of: providing a project management software platform running on a server 105; providing one or more electronic data processing units 110; accessing on an administrative basis the project management software platform via at least one of the one or more electronic data processing units in order to set up one or more projects 115; creating a plurality of user accounts on the project management software platform 120; setting up said one or more projects via the project management software platform 125; accessing by a user the project management software platform via a user login through at least one of the one or more electronic data processing units 130; presenting to the logged-in user said projects to which said logged-in user has access 135; uploading by the user the one or more files associated with the one or more projects to at least one of said plurality of project icons within at least one of the one or more projects 140; and viewing by at least one second user said one or more uploaded files on the at least one display with minimal time wasted in finding the one or more uploaded files 150.

FIG. 1 shows the first step of the method 100, which may be providing a project management software platform running on a server 105. A software program is generally any computer readable instructions that cause the processor to perform the methods and processes disclosed herein when the instructions are executed by the processor.

The project management software platform may reside on the server or may be configured to communicate with the server via a network such as the Internet, such that the project management software platform transmits and receives data/content to and from the server. Typically, the project management software platform resides on the server and is accessed by users through the Internet through a computer or other type of electronic data processing unit. The project management software application may also be configured to allow a user to input and store job-related information and files into the user's folder associated with that user's account. The project management software platform may have a user interface configured to receive or obtain one or more user inputs or parameters and may be configured to receive content from the server and convert such content. The device used by the user to access the project management software platform may have a display, which is how the user may view the graphical user interface of the project management software platform. Additionally, the project management software platform may be configured to store and run any media content such as audio, video, and image files and may comprise user account information such as a username and password.

FIG. 1 also shows the second step of the method 100, which may be providing one or more electronic data processing units 110. Electronic data processing units may refer to any device that processes information with an integrated circuit chip, including without limitation, personal computers, mainframe computers, workstations, servers, desktop computers, portable computers, laptop computers, embedded computers, wireless devices including cellular phones, personal digital assistants, tablets, tablet computers, smartphones, portable game players, and hand-held computers.

The project management software platform may allow project managers and other account users to easily see videos, images, documents, reports, and other work-related documents and files, which are related to a particular job that is uploaded to the server or system. The work-related documents and files may be well organized, quickly uploaded, and instantly accessible from anywhere and through any electronic data processing device or computer. The job-related data may be collected as a single data set or distributed over various locations, including over different electronic data processing units, and may exist, at least partially, merely as electronic signals on a system or network.

FIG. 1 shows the third, fourth, and fifth steps of the method 100, which may be accessing on an administrative basis the project management software platform via at least one of the one or more electronic data processing units in order to set up one or more projects 115; creating a plurality of user accounts on the project management software platform 120; and setting up the one or more projects via the project management software platform 125. A business' administrative user(s), such as a business owner, project managers, president, vice president, authorized agent, and/or any other person in a position with the authority to access the project management software platform by way of any electronic data processing units, may access the project management software platform. The administrative user may then create user accounts for whomever the business desires, to enable the administrative users, account users, employees, and customers to upload and store job-related information and to permit the designated users to view the uploaded job-related information. If the business desires, an administrative user, or even an account user, customer, or employee, may then access the administrative or user accounts, respectively, to update projects on the project management system.

FIG. 1 shows the sixth, seventh, and eighth steps of the method 100, which may be accessing by a user the project management software platform via a user login through at least one of the one or more electronic data processing units 130; presenting to the logged-in user the projects to which the logged-in user has access 135; and uploading by the user the one or more files associated with the one or more projects to at least one of the plurality of project icons within at least one of the one or more projects 140. Once user accounts are created, each user may be able to login—using an electronic data processing unit that permits such login—to his or her account by entering certain requested identifying information, such as a username and password. The logged-in user will then be able to view various job- and project-related information and specifics to which the administrative user and/or project creator has granted access. For example, these specifics may include the contact information of clients and client billing information pertaining to a particular job or task. The scope of what the account user can see may be limited according to the administrative user and/or project creator's wishes. The account user may be able to upload new documents, files, videos, images, and other job-related data and information to the project management software platform for his or her subsequent viewing and for the viewing of administrative users.

FIG. 1 also shows the ninth step of the method 100, which may be viewing by at least one second user the one or more uploaded files on the at least one display with minimal time wasted in finding the one or more uploaded files 145. Once an account or administrative user has uploaded files in to the system, these files can then be immediately accessed and reviewed by other users to whom the administrative users or project creators have allowed access.

Although FIG. 1 shows only nine steps, it should be understood that any number of steps may be used, and that some steps may be performed at the same time or out of order.

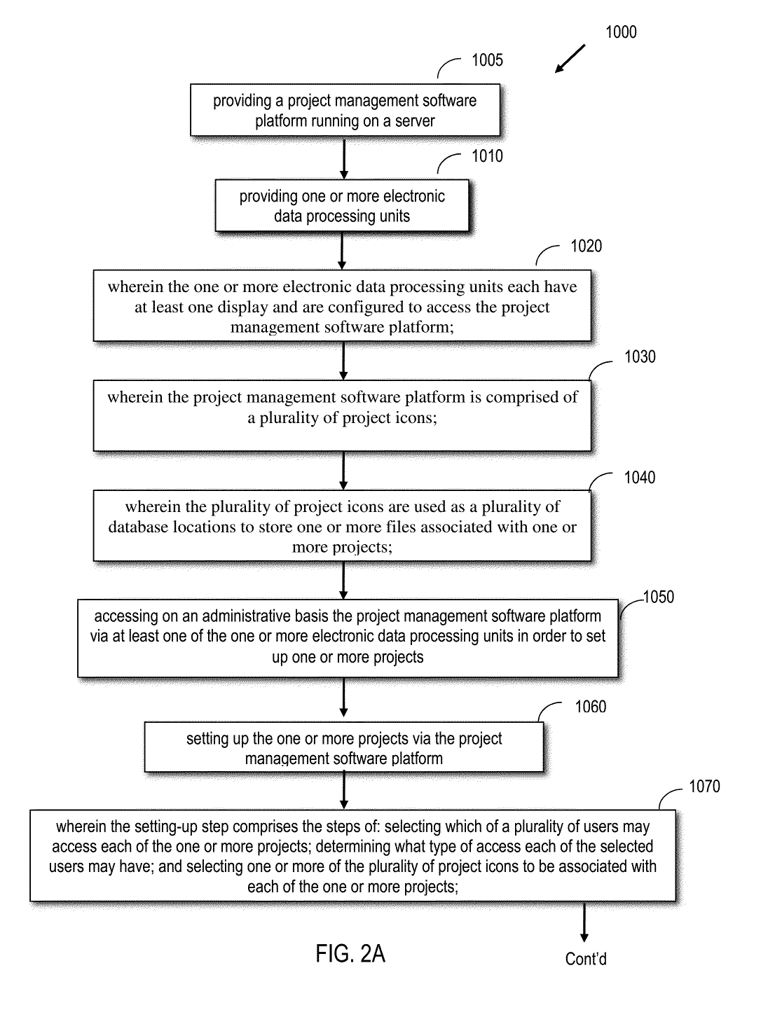

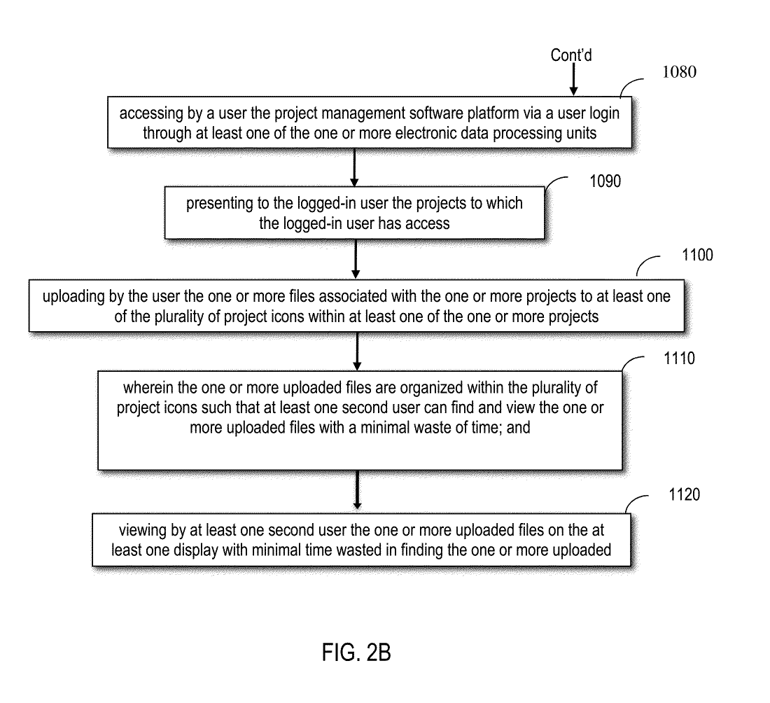

FIGS. 2A and 2B are a flow chart of another embodiment of the project management method. As shown in FIG. 2, another embodiment of the method 1000 may comprise the steps of: providing a project management software platform running on a server 1005; providing one or more electronic data processing units 1010; wherein the one or more electronic data processing units each have at least one display and are configured to access the project management software platform 1020; wherein the project management software platform is comprised of a plurality of project icons 1030; wherein the plurality of project icons are used as a plurality of database locations to store one or more files associated with one or more projects 1040; accessing on an administrative basis the project management software platform via at least one of the one or more electronic data processing units in order to set up one or more projects 1050; setting up the one or more projects via the project management software platform 1060; wherein the setting-up step may comprise the steps of: selecting which of a plurality of users may access each of the one or more projects; determining what type of access each of the selected users may have; and selecting one or more of the plurality of project icons to be associated with each of the one or more projects 1070; accessing by a user the project management software platform via a user login through at least one of the one or more electronic data processing units 1080; presenting to the logged-in user the projects to which the logged-in user has access 1090; uploading by the user the one or more files associated with the one or more projects to at least one of the plurality of project icons within at least one of the one or more projects 1100; wherein the one or more uploaded files are organized within the plurality of project icons such that at least one second user can find and view the one or more uploaded files with a minimal waste of time 1110; and viewing by at least one second user the one or more uploaded files on the at least one display with minimal time wasted in finding the one or more uploaded files 1120.

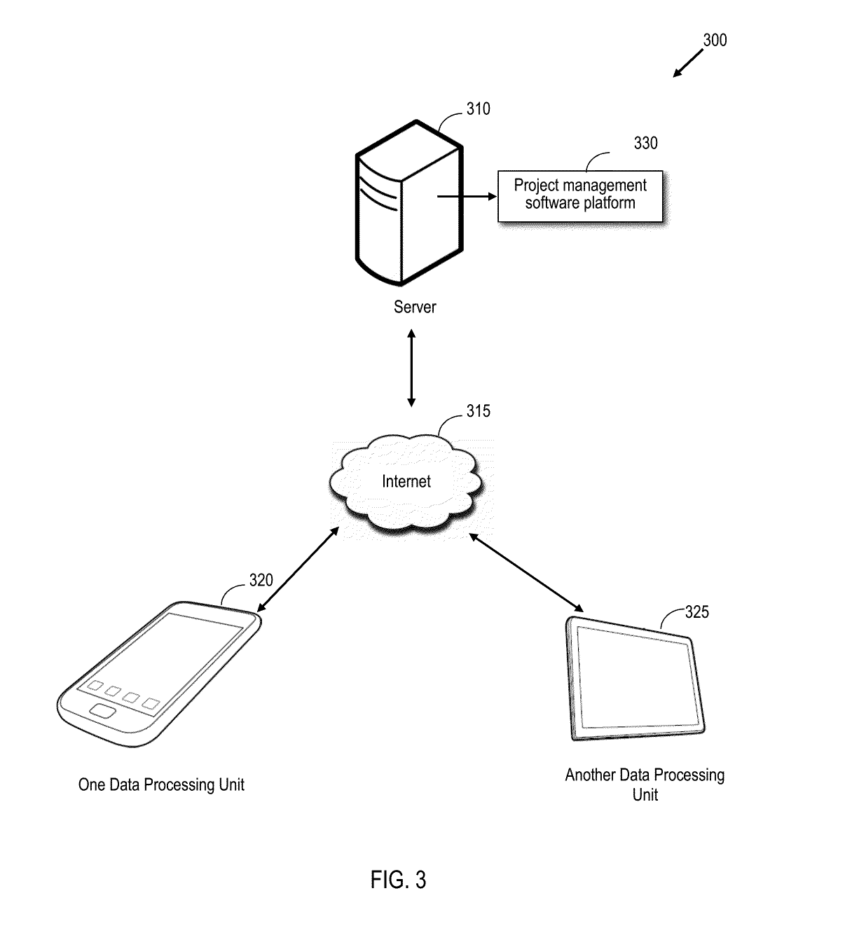

FIG. 3 is a flow diagram of one embodiment of the system for the project management method. As shown in FIG. 3, an embodiment of the system 300 for the project management method may comprise: a server 310, Internet 315, and one or more electronic data processing units 320, 325, which are generally used to access the project management software platform 330, which may reside on server 310. As discussed above, the server 10 may be another computer, database, or hardware system that manages access to a centralized resource or service in a network. The Internet 315 may be a computer network comprising a worldwide network of computer networks that generally use TCP/IP networking protocols to facilitate data transmission and exchange. The electronic data processing units 320, 325 may be any computing device, which are generally designed for individual use, and may connect to the Internet 315 or World Wide Web. Alternatively, the project management software platform 330 may also be an application on the units 320 and 325, and the connection may be through a dedicated enterprise Intranet.

FIG. 3 also shows how the system 300 may be performed. Specifically, an administrative user utilizing the project management software platform 330 may create different accounts for different users using a single data processing unit 320. Once created, the account information may be stored in the server 310. The user accounts—and the different job-related projects on these user accounts—may be displayed to account users via the project management software platform 330 of the same data processing unit 320 or another data processing unit 325. The account user may then provide and manage job-related inputs into their designated accounts, wherein the inputs may become input data, which may also be stored in the server 310. The user may then access the software platform 330 from any computer because they may have a unique user name and password.

Although FIG. 3 shows a smartphone as one data processing unit 320 and tablet as another data processing unit 325, any type of computer or electronic device may be used such as a desktop computer, laptop, or any other streaming device. Additionally, it should be understood that any number of users may utilize the method 100 of the project management method.

In a preferred embodiment, an administrative user may create a user account for an account user, using the project management software platform 330 on one data processing unit 320. After a user's account it created, the user may input job-related data into the user's account. The project management software platform 330 may receive an input from the account user, and the input may become input data, which is generally stored in the server 310. The input data may comprise many forms of data, including but not limited to videos, images, reports, work orders, and billing information. After receiving an input from the account user, the project management software platform 330 may display the job-related input data to the account user, to the administrative user, and to any other person an administrative user deems appropriate.

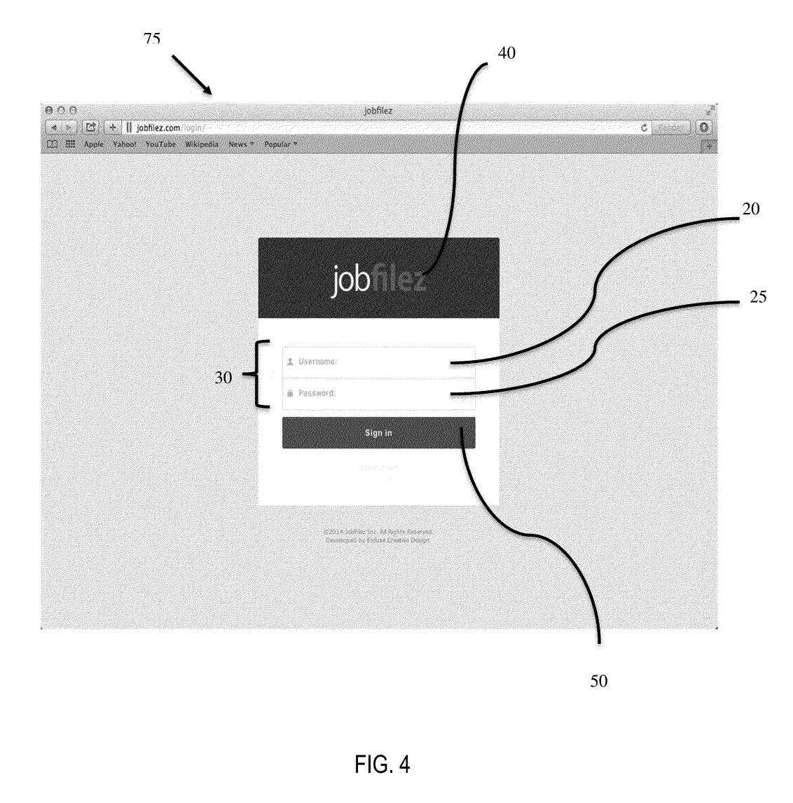

FIG. 4 is a screen shot of one embodiment of the project management method and shows the login screen. As shown in FIG. 4, one embodiment of the project management method may have a login screen 75, which may further comprise a logo and/or trademark 40 and sign-in 30. FIG. 4 shows that the starting page or screen for accessing a user account on the project management method is a sign-in screen 75. The user may access his or her page by logging in using a sign-in 30, which may comprise a username 20, password 25, and execute, “sign in”, or login button 50. In the event that the user has not yet set up or created a username 20 and password 25, the user may register for a user account on a registration page. Typically, the registration is done by an administrator user.

FIGS. 4-23 show one embodiment of a graphical user interface of project management software platform 330, as it may appear on various user computers and other electronic data processing units. It should be understood that many different graphical user interfaces may be used as part of the method.

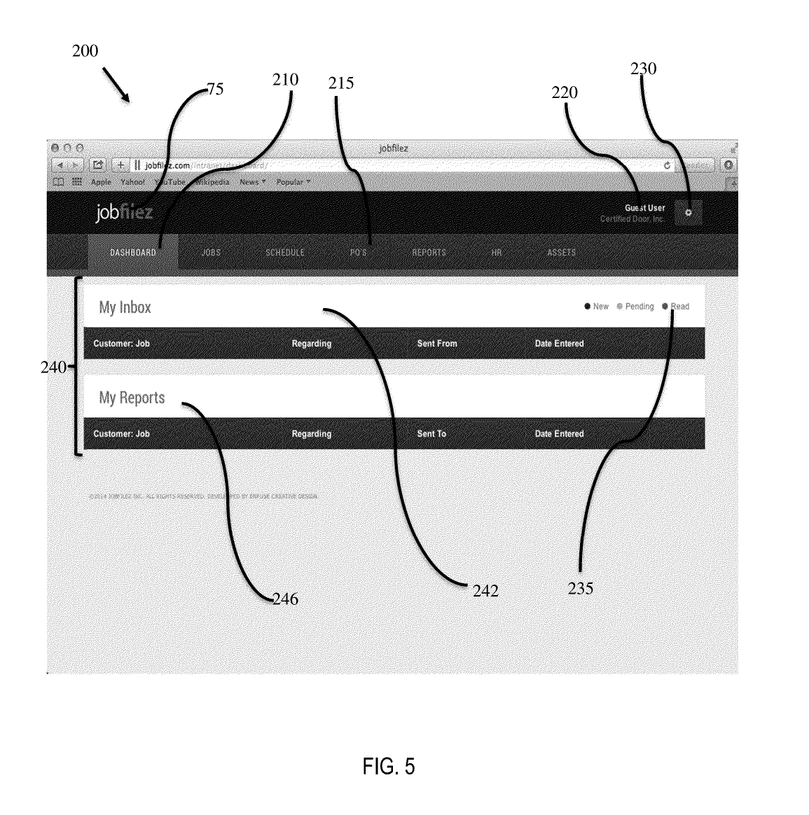

FIG. 5 is a screen shot of one embodiment of the project management method and shows the home screen. As shown in FIG. 5, one embodiment of the home screen 200 may comprise: a logo and/or trademark 75, an active tab 210, inactive tabs 215, a settings icon 230, a color-coded key 235, and information tables 240. The logo and/or trademark 75 may appear on every screen of the project management method. The active tab 210 may be any tab highlighted in a bright color, and may indicate that only the panel whose corresponding tab is active is visible. The inactive tabs 215 may appear in gray, or in any other muted color. A desired tab's panel may be accessed by clicking, selecting, or tapping on the desired tab. The active tab 210 and inactive tabs 215 may include any information desired by the account user or business owner, such as the following tabs: Dashboard, Jobs, Schedule, PO's, Reports, HR, and Assets, as seen in the home screen 200. However, the labeling, content, and number of active and inactive tabs 210, 215 can be adjusted according to an account user's or business administrator's preferences. The settings icon 230 may allow a user to alter an account's settings and to chat or message other account users. The color-coded key 235 may indicate to the user whether information located on the information tables 240, among other things, is new, is pending, and has been read or viewed.

FIG. 5 also shows that the information tables 240 may comprise various information on the home screen 200, including but not limited to an inbox table 242 and a reports table 246. Informational tables 240 may be added or removed at the user's and/or administrator's choosing. Relevant information contained within these informational tables 240 may include, but not be limited to, information indicating a particular job, correspondences, reports, relevant dates, etc . . . .

FIG. 5 may also display identifying user data 220. This identifying user data 220 may comprise an account user's name and/or business for which the account user is using the account. More or less identifying user data may be displayed, depending on the account user's or administrator's preferences.

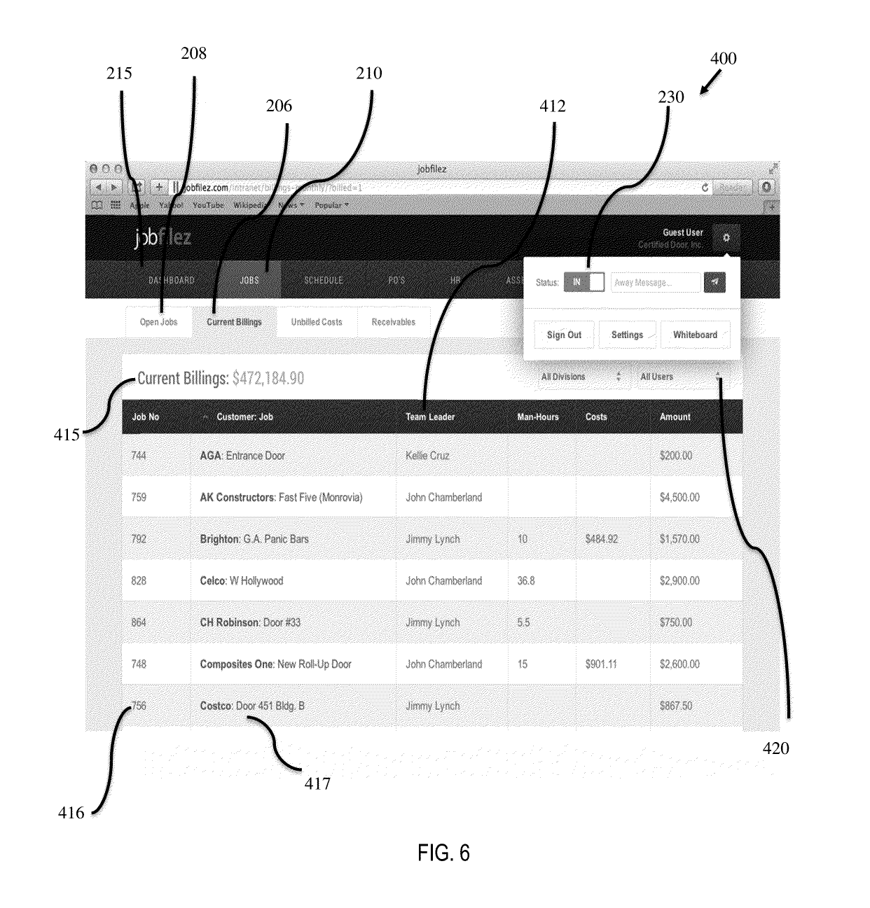

FIG. 6 is a screen shot of one embodiment of the project management method and shows one embodiment of the jobs folder. As shown in FIG. 6, one embodiment of the jobs folder 400 may comprise: an active sub-tab 206, inactive sub-tabs 208, and a current billing status 415. The active sub-tab 206 is highlighted to distinguish itself from the inactive sub-tabs 208, and generally contains a panel of information related to the information found in the current billing status 415. The current billing status 415 may display the sum or total amount of the jobs that the user or business may be involved with. The current billing status 415 may also contain current billing information for a particular user in a particular division. The particular user and/or particular division can be selected using the drop-down menus 420. The active sub-tab may also list the general job data 412, which is typically data that must be inputted into the project management method to help organize, analyze, and calculate the current billing status 415. The general job data may include information such as a job number, job name, job description, name of the team leader, number of man-hours performed on the job, additional costs, and the total amount of billings for the job and may display such information in columns, as shown in FIG. 6. The active sub-tab 206 may provide additional information or data displayed in rows 416. Additionally each row 416 may provide links to more in-depth information regarding the job, such as a job description link 417, which may offer additional job-related details.

As shown in FIG. 6, the active tab 210 of the job folder 400 may be the jobs tab. However, other tabs may be selected as the active tab. FIG. 6 also shows a settings icon 230, which generally allows an account user to select different account settings such as accessing the whiteboard, signing into or out of chat, and creating an away message. The settings icon 230, however, is not limited to these functions.

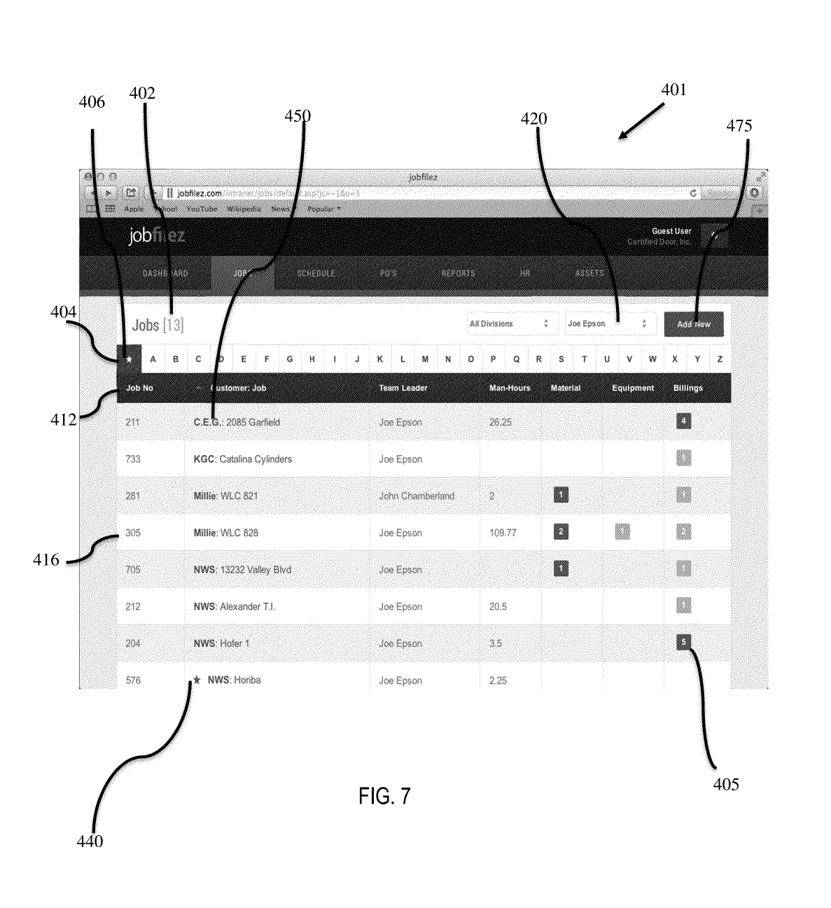

FIG. 7 is a screen shot of one embodiment of the project management method and shows another embodiment of the jobs folder. As shown in FIG. 7, another embodiment of the jobs folder 401 may comprise: general job data 412, rows 416, drop-down menus 420, job titles 450, color-coded signalers 405, and an alphabetized index 404. The general job data 412 for the data rows 416 on the jobs screen 400 may vary depending on the administrator's desire, and may include information such as the job number, job title 450, team leader for a particular job, number of man-hours applied towards a job, materials, equipment, and billings for a particular job. The color-coded signalers 405 may show, among other things, the different numbers and levels of completion, among other things, of the materials, equipment, and billings information. The alphabetized index 404 may include the title of the job in alphabetical order and may allow a user to search for a particular job based on the first letter of the job name. The alphabetized index 404 may also allow a user to see all open jobs by selecting the star tab 406 in the alphabetized index 404. The star tab 406 may appear in any color to indicate that the user has selected the star tab. The findings number 402 may show how many different results are found. As shown in FIG. 7, for example, there may be thirteen (13) open jobs available, as indicated by the findings number 402.

FIG. 7 may also show that the jobs screen 401 may include job-related information for a specific user, who may be indicated in one of the drop-down menus 420. A different user may be selected, and the open jobs may then be viewed for that different user. FIG. 7 also shows and “add new” or create button 475 to allow an account user to populate or fill in all the general job data 412 and add a new open job to the list. FIG. 7 also shows job titles 450 for each corresponding job number. The job titles 450 may also allow a user to click, select, or tap on a specific job title in order to view more information on that particular job. A job title 450 may also have an identifier 440, such as a colored star, next to it to indicate that a special note exists regarding that particular job.

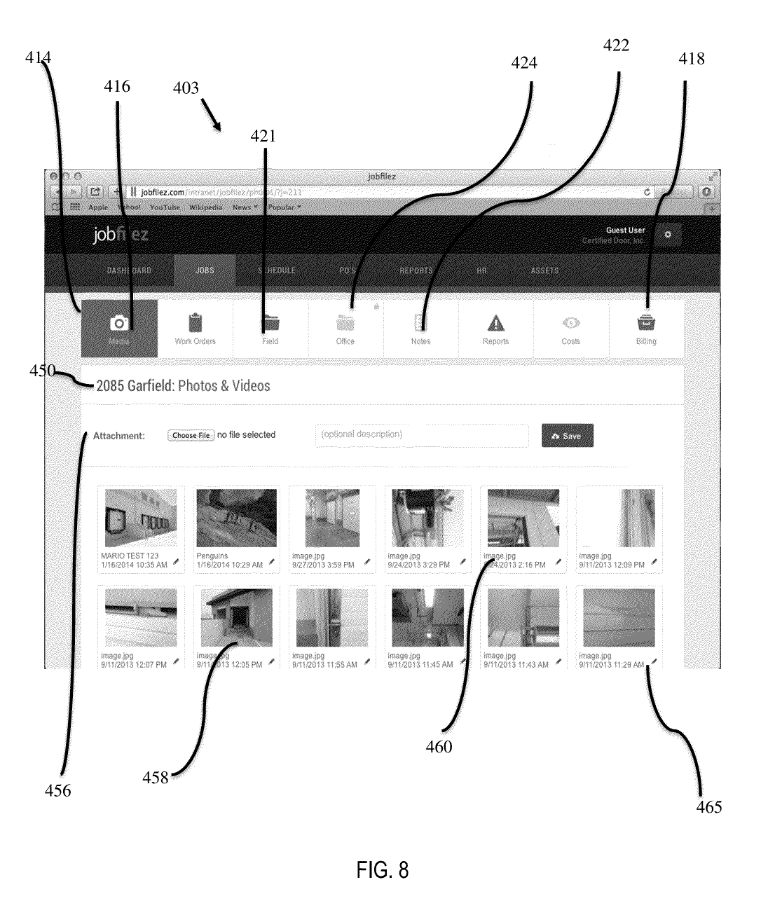

FIG. 8 is a screen shot showing one embodiment of the project management method and shows one embodiment of the media page of the jobs screen. As shown in FIG. 8, one embodiment of the media page 403 of the jobs screen 400 may comprise: a viewing bar 414, an active viewing tab 416, inactive viewing tabs 418, a job title 450, an attachment button 456, images and/or videos 458, image or video information 460, and an edit option 465. The viewing bar 414 shows the different options for viewing a particular job's job-related matter. For example, in FIG. 8, the viewing bar 414 may provide a user with the opportunity to view media, work order, field documents, office documents, notes, reports, costs, and billings for a particular job, but may include other options as well.

As shown in FIG. 8, the jobs screen 400 may also contain an attachment button 456, which may allow a user to select a file to attach, provide a description of the file to be attached, and save the file to the specific media page on the account. FIG. 8 also may allow a user to view already-posted videos or images 458, view image or video information 460, and edit the attached image or video file or other image or video information 460 using the edit option 465.

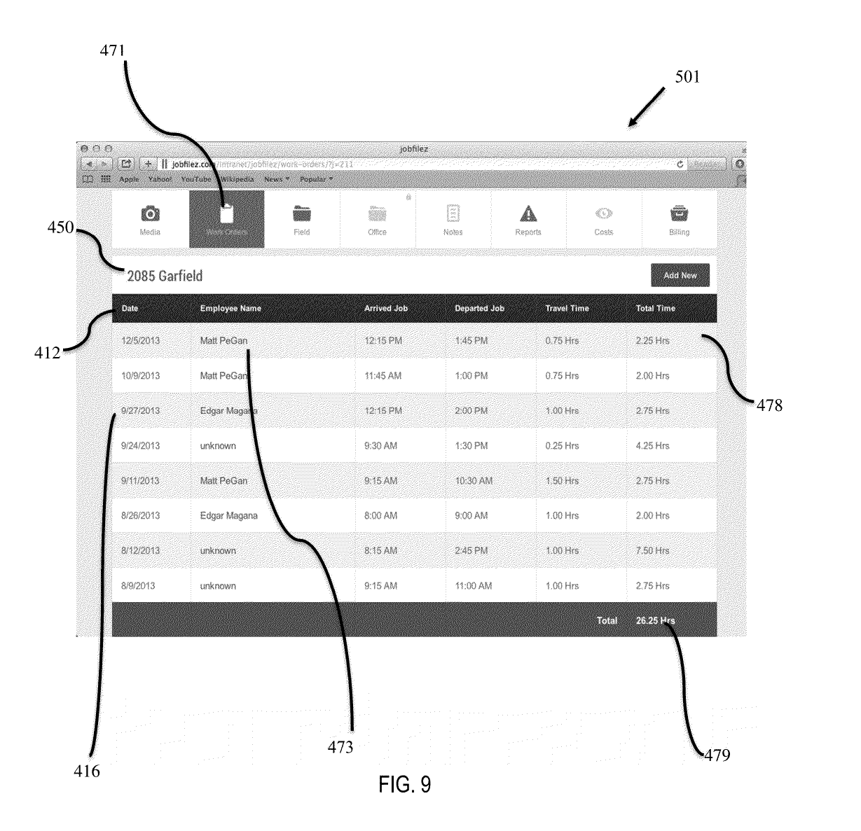

FIG. 9 is a screen shot of one embodiment of the project management method and shows the work orders screen of the jobs folder. As shown in FIG. 9, one embodiment of the work orders screen 501 may comprise: general job data 412, data 416, name of employee 473, specific task duration 478, and a cumulative task time 479. The general job data 412 may include the date of the work order, the employee who responded to the work order, the time the employee arrive at and departed from the job, the travel time required, and the total for the specific task time 478. The specific task duration 478 may include the total time, in which an employee traveled and/or the time, in which the employee was at the job responding to a work order. FIG. 9 may also include the cumulative task time 479, which consists of all specific task durations 478 added together.

As shown in FIG. 9, the employee name 473 may consist of a link that, when selected, may provide more information regarding a particular selected employee. This information may include a list of work orders that a particular employee has completed for a particular job. FIG. 9 also shows the job title 450, which may provide a link to more in-depth job-related information for that particular job.

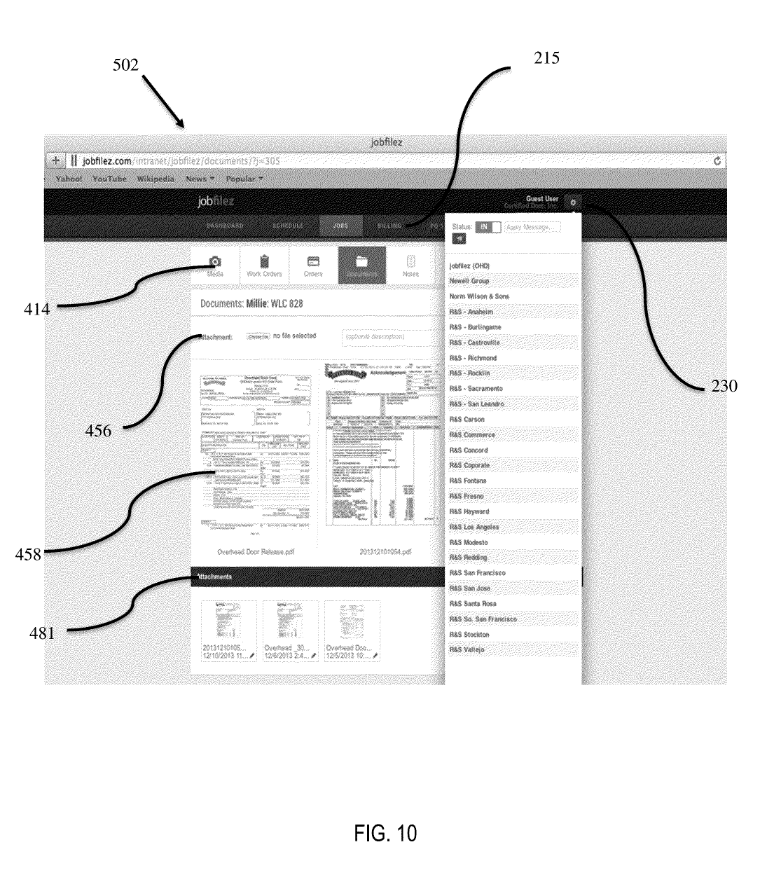

FIG. 10 is a screen shot of one embodiment of the project management method and shows the documents screen. As shown in FIG. 10, one embodiment of the documents screen 502 may comprise: a viewing bar 414, attachment button 456, document images 458, attachment display 481, and settings icon 230. The viewing bar 414 may show the different options for viewing a particular job's job-related matter. For example, the viewing bar 414 may allow a user to view the purchase orders. Similarly, FIG. 10 also shows an inactive tab 215 for billings when other figures do not.

FIG. 10 also shows document images 458, or the first page of an attached document, which was attached via the attachment button 456. The document images 458 may be clicked, selected, or tapped on in order to allow a user to view the attached document in an enlarged form and in its entirety. The attachment display 481 may permit the user to view all attachments for the particular job and may display helpful information that relates to those attachments, such as the date of the attachment and the title. The user may also click on or tap a file in the attachment display 481 to view the attached document in an enlarged form and in its entirety.

The documents screen 502 may include field documents and office documents. However, field documents and office documents may also be located at separate tabs of the viewing bar 414. Additionally, the settings icon 230 may allow a user from a company with multiple locations to easily switch between offices.

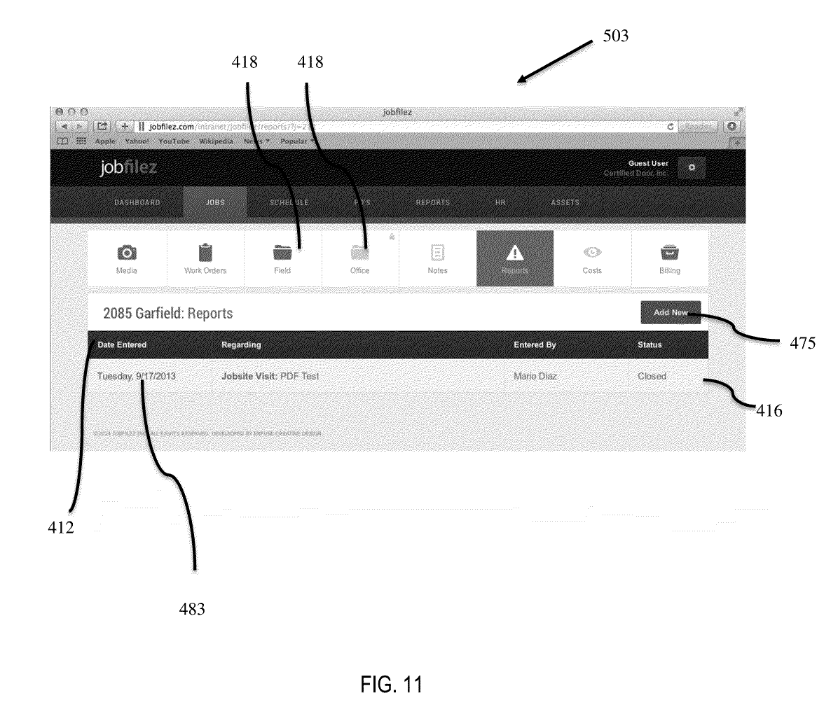

FIG. 11 is a screen shot of one embodiment of the project management method and shows the reports screen of the jobs folder. As shown in FIG. 11, one embodiment of the reports screen 503 may comprise an entry date 483. The entry date 483 generally provides a user a particular job and may allow a user to select a report to view for that particular job. A user may use the “add new” or create button 475 to create a new entry and/or add a new report. The information prompted for a report may be shown on the job data 412. For the reports screen 503, the job data 412 may include, without limitation, the date the report was entered, the description of the report, the name of the submitter of the report, and the status of the report. Such information may then appear in the job data 416. Reports may pertain to particular jobsite visits, regardless as to whether the report is a reminder to visit a jobsite on a particular day or a reflection on an upcoming a jobsite visitation.

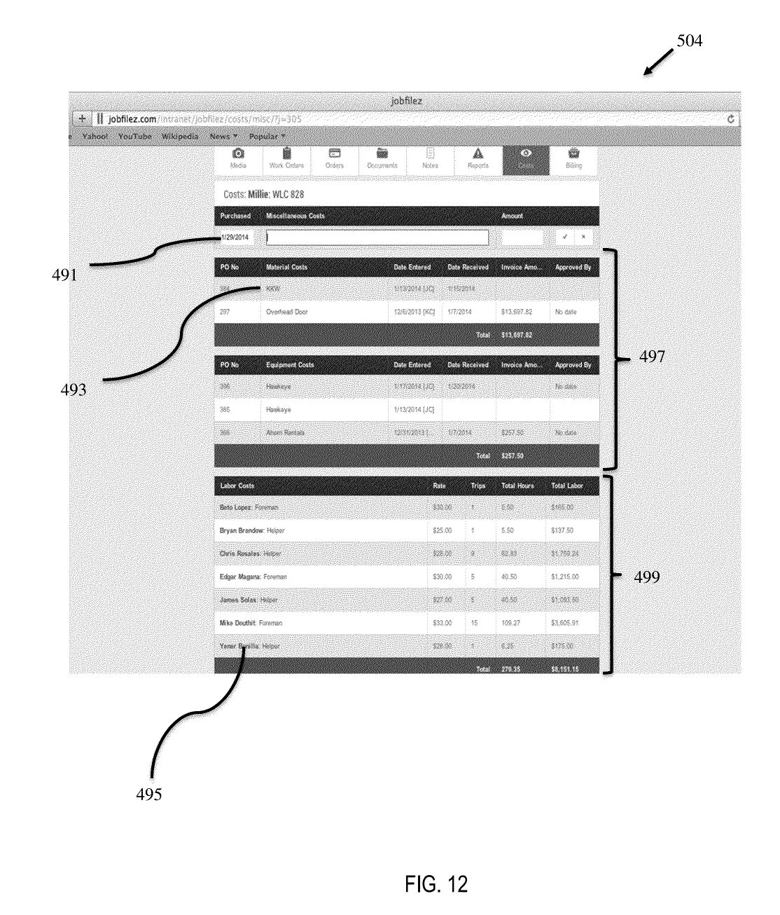

FIG. 12 is a screen shot of one embodiment of the project management method and shows the costs screen of the jobs folder. As shown in FIG. 12, one embodiment of the costs screen 504 may comprise: a data entry field 491, purchase order cost entries 497, and work order cost entries 499. The purchase order cost entries 497 may comprise purchase orders 493, and the work order cost entries 499 may include one or more work orders 495. The data entry field 491 may permit a user to enter information relating to a job expense, such as the date of purchase, description of cost, amount of the cost and whether the cost is approved or denied. The date may be entered either by inputting a specific date or by selecting a specific date from a calendar. The date may also be automatically entered depending on when a user attempts to create an entry into the data entry field 491. Once selected, the purchase order links 493 may take a user to another screen to view more in-depth details about the purchase order for a particular job. Similarly, once selected, the work orders 495 may take the user to another screen to view more in-depth details regarding work orders completed by a particular individual on a particular job.

As shown in FIG. 12, the purchase order cost entries 497 may include information relating to material and equipment costs, the purchase order number, the date the purchase order is entered and received, the name of the person who submitted the purchase order; the invoice amount; and the date, or lack thereof, as to when the purchase order was approved. The purchase order cost entries 497 may comprise the cumulative total number of hours and the labor costs for a particular job. The work order cost entries 499 may comprise work order information for a particular job, such as the name and position of the worker who completed the work order, the rate of the fees and/or costs of the job, number of trips, length of time to complete the work order, and the total cost for a particular worker to complete the work orders. The work order cost entries 499 may comprise the cumulative total number of hours and labor costs for a particular job.

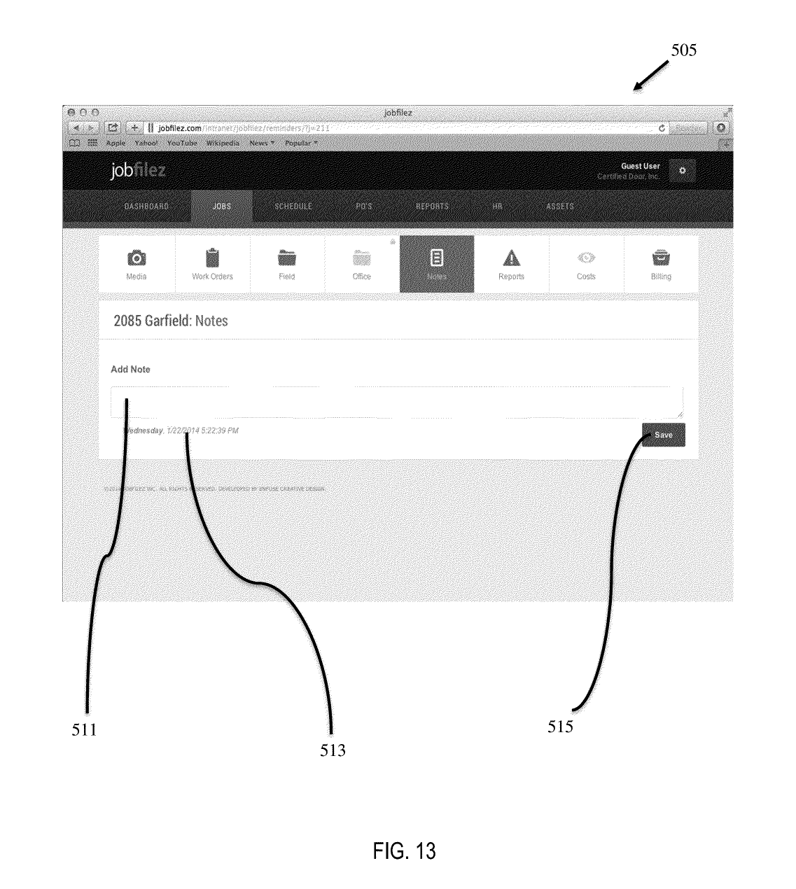

FIG. 13 is a screen shot of one embodiment of the project management method and shows the notes screen of the jobs folder. As shown in FIG. 13, one embodiment of the notes screen 505 may comprise: a notes entry field 511, a time-stamp 513, and a “save” function 515. The notes entry field 511 may permit a user to input notes regarding a particular job. The information entered into the notes entry field 511 may then be saved using the “save” function 515. Notes are generally time-stamped 513 when they are saved. Such time-stamp information 513 may include the day, week, month, year, and/or the time of day.

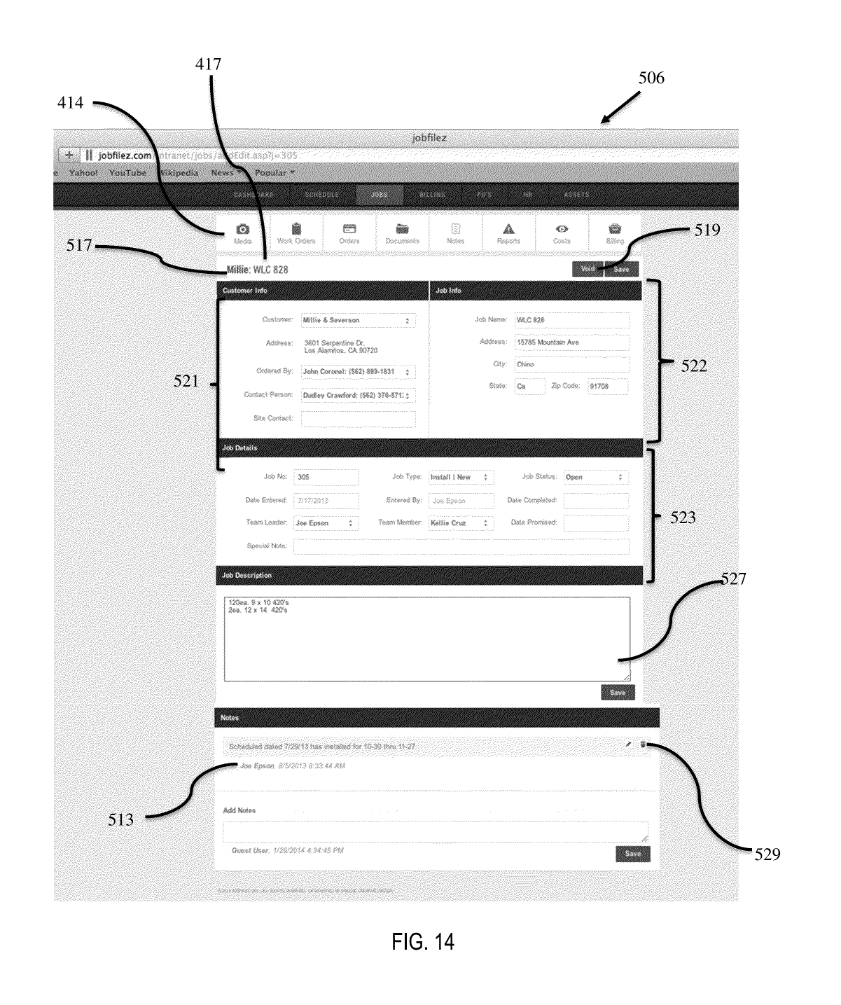

FIG. 14 is a screen shot of one embodiment of the project management method and shows the job details screen. As shown in FIG. 14, one embodiment of the jobs details screen 506 may comprise: a job description link 417, a client identifier 517, customer information 521, basic job information 522, detailed job information 523, job description 527, and pre-existing job notes 529. The job description link identifies which particular job the information on the job specifics screen 506 pertains. The job description link 417 may be selected from the job description link on other screens of the project management system, which in turn, may lead to the job specifics screen 506. The client identifier 517 may show or identify the client pertaining to a particular job. The client identifier 517 may be a link that can transfer a user from one screen to another screen that may display a list of all jobs for a particular client. The customer information 521 may show customer-specific information such as the customer's name, address, and person of contact, to name a few. The basic job information 522 may comprise information such as the job name and address. The detailed job information 523 may identify the job number, type, status, entry date and person, completion and processing date, team leader and members on the job, and special notes, among other things. The job description 527 may describe the job function and what the client is requesting.

As shown in FIG. 14, the jobs specifics screen 506 may show any pre-existing job notes 529, and may provide a user with the opportunity to either edit or discard the pre-existing job notes 529. The pre-existing job notes 529 also may include a time-stamp 513 for when the pre-existing note was created, and by whom.

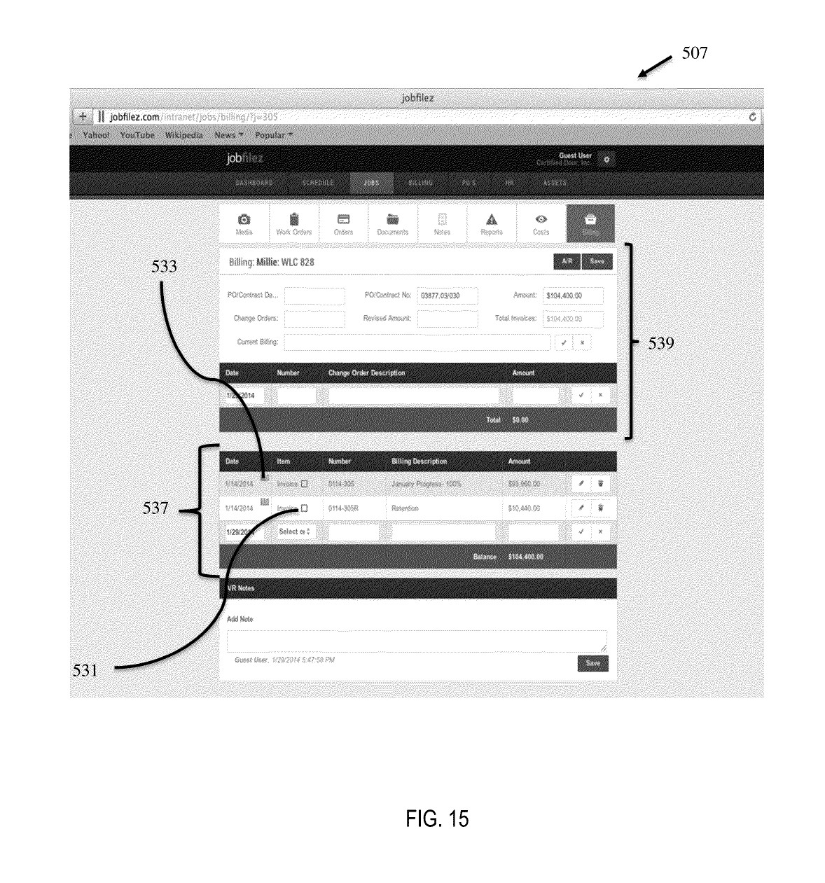

FIG. 15 is a screen shot of one embodiment of the project management method and shows the billing screen. As shown in FIG. 15, one embodiment of the billing screen 507 may comprise: a billing details 539 and a billing invoices 537. The billing details 539 may allow a user to enter information regarding a purchasing order, contract, or any other item for which a client may be billed. This information may include, a Purchase Order, contract date and number, the billing amount and/or revised amount, the total billing amount for all invoices with respect to a particular job, order change information, and a description of the billing.

FIG. 15 also shows billing invoices 537, which may provide information as to which invoice or a payment corresponds to a particular bill. Additionally, the billing invoice may prompt a user to enter a billing number, description, amount, and to edit or discard the billing entry. The billing information section 537 may include a numeral 533, which may specify by which date an invoice must be sent or paid. The billing information section 537 may also include a confirmation box 531, which may indicate whether the invoice has been sent or the payment has been received. The confirmation box 537 may remain unchecked until a user clicks or selects on the confirmation box 537 to show the invoice has been sent or the payment has been received.

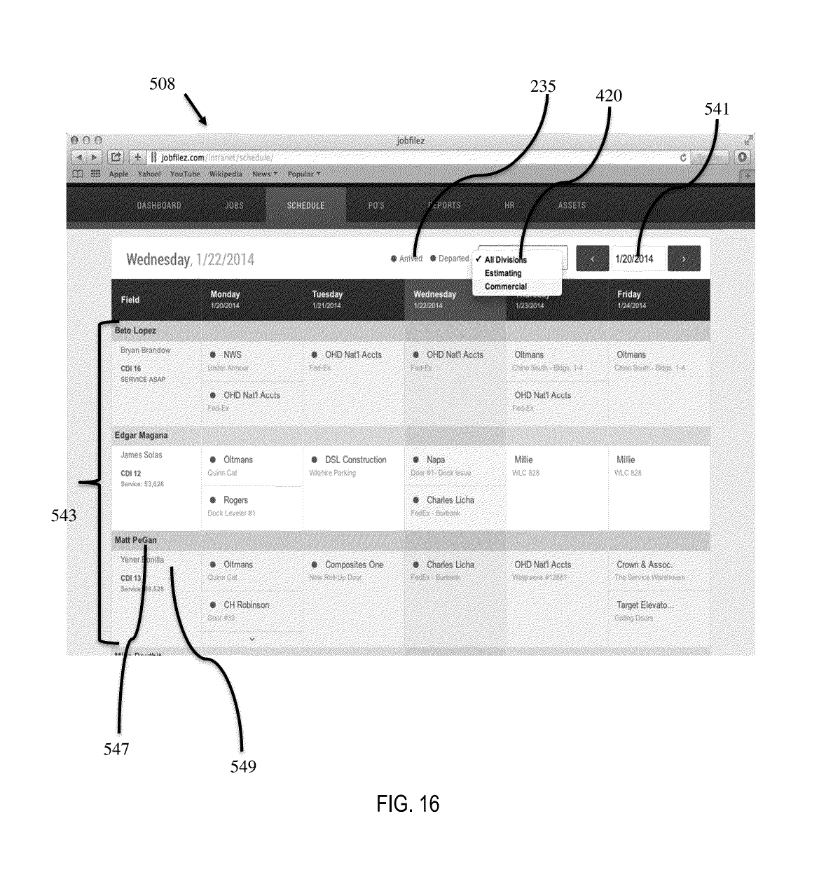

FIG. 16 is a screen shot of one embodiment of the project management method and shows the schedule screen. As shown in FIG. 16, one embodiment of the schedule screen 508 may comprise: a color-coded key 235, drop-down menu 420, date selection drop down menu 541, calendar 543, individual-employee schedule 547, and service information 549. The color-coded key 235 may also permit account users and/or administrators to maintain the statuses of particular job function such as when an employee has arrived at and departed from a particular job. The drop-down menu 420 may allow a user to select a particular job division such as estimating or commercial, but may be selected to view all job divisions. The date selection tool 541 may permit a user to view the calendar entries for a particular date in the past, present, or future. The all-employee calendar 543 may allow a user to view the schedules of each employee on a desired day or week. The information from the date selected using the date selection tool 541 may appear highlighted to distinguish that date from the other non-selected dates. The individual-employee schedule 547 may also allow a user to view the schedules for an individual employee. The service information 549 permits a user to see who may be the assistant or helper for a particular employee on a particular week, the company vehicle that an employee is assigned to for a particular week, and whether the vehicle needs to be serviced as soon as possible or once it reaches a particular mileage.

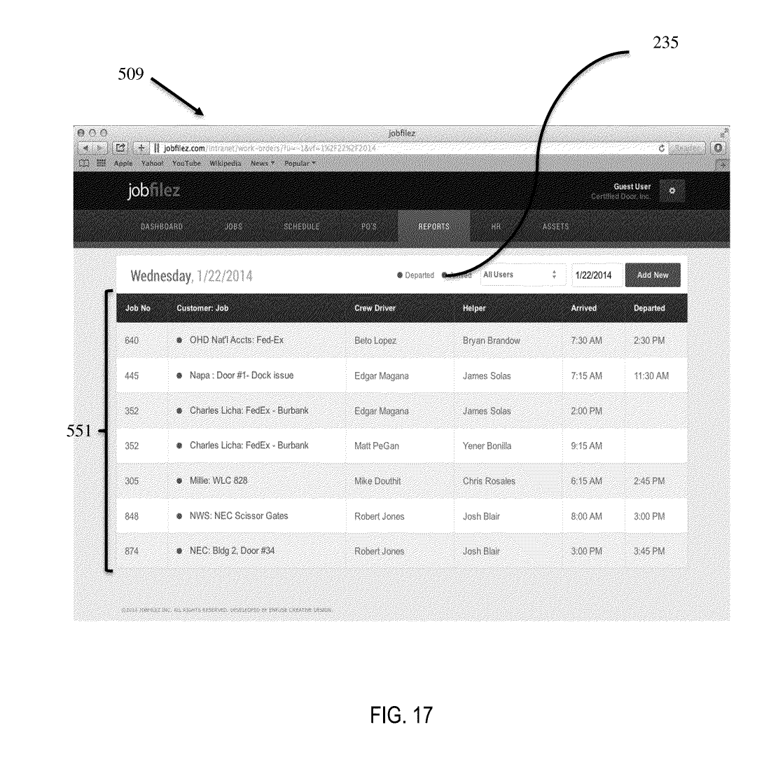

FIG. 17 is a screen shot of one embodiment of the project management method and shows the reports main screen. As shown in FIG. 17, one embodiment of the reports main screen 509 may comprise: a color-coded key 235 and a report display 551. The report display 551 may show all reports for a selected calendar date. The reports for a particular date may be viewed for all users of the system, or for just one account user. The information on the report display 551 may include, among other things, the job number, customer and job designators, the driver and any helper on each job, and the arrival and departure date. Additionally, the report display 551 may be color-coded, according to the color-coded key 235, so as to signal to an account user or administrator as to what stage in the reporting process a particular driver is at—e.g., whether and at what time the driver has arrived or departed from the job. For example, if a driver has yet to depart from a job, the departure time may be left blank. Similarly, there may also be an indication of this with or without using a designated color from the color-coded key 523, and the arrival time would be left blank. On the other hand, if a driver has arrived at and/or departed from a job, the arrival and departure time would be noted.

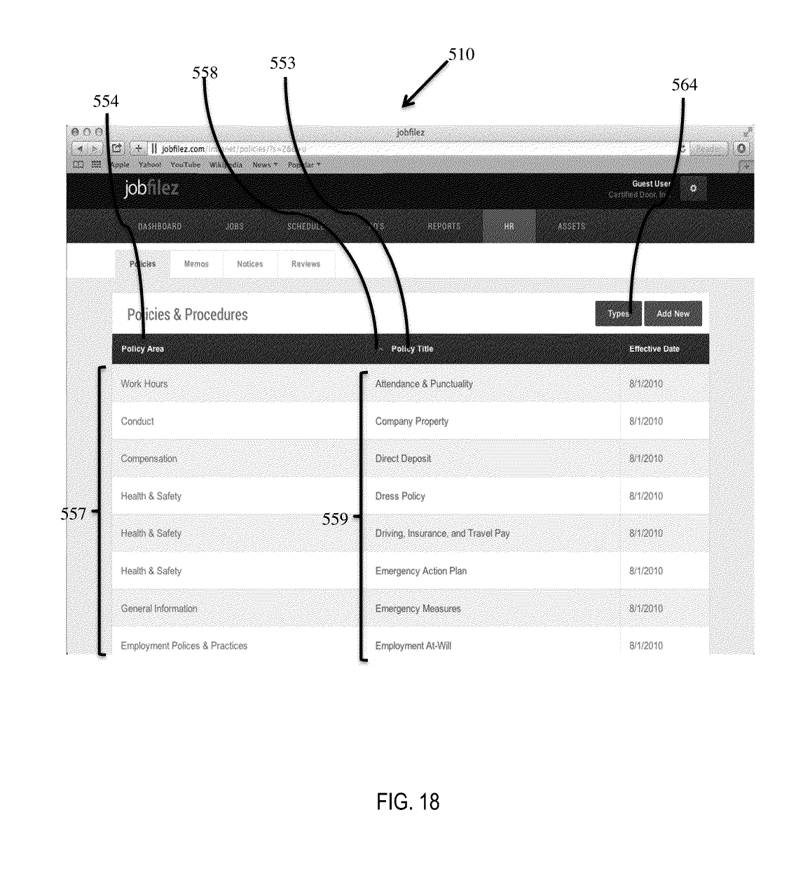

FIG. 18 is a screen shot of one embodiment of the project management method and shows the policies and procedures screen. As shown in FIG. 18, the policies and procedures screen 510 may comprise: policy title 553, policy area 554, policies 559, and a policy type filter 564, wherein the policy area 554 and policy title 553 may comprise one or more policies 559 and their respective policy area 557. The policies and procedures screen 510 may categorize the different policies and may allow a user to search for a policy by looking to an applicable policy area 557. The policies and procedure screen 510 may also provide information on future policies to be posted, such as the date by when a policy will be posted. The policies and procedure screen 510 may also allow a user to view a policy even if the effective date has not yet passed. Additionally, the policies and procedure screen 510 may comprise a policy type viewer 564, which may allow a user to view all of the different types of policies and number of entries for each type of policy, and select a policy type in order to more readily view only the entries for a particular type of policy.

A sorting function 558 may allow a user to filter the amount of information displayed on the screen, whether it is displayed in alphabetical order, in reverse alphabetical order, or by the effective date of the policy. For example, FIG. 18 shows that the policy title 553 may be sorted Other variations in sorting the policy-related information may also be used.

As also shown in FIG. 18, a user and/or administrator may allow a user to easily access the different company policies. The user may also assess the applicability of the policies by looking to the effective date of the policy. The policy links 559 may allow a user to click or tap on a particular policy for viewing.

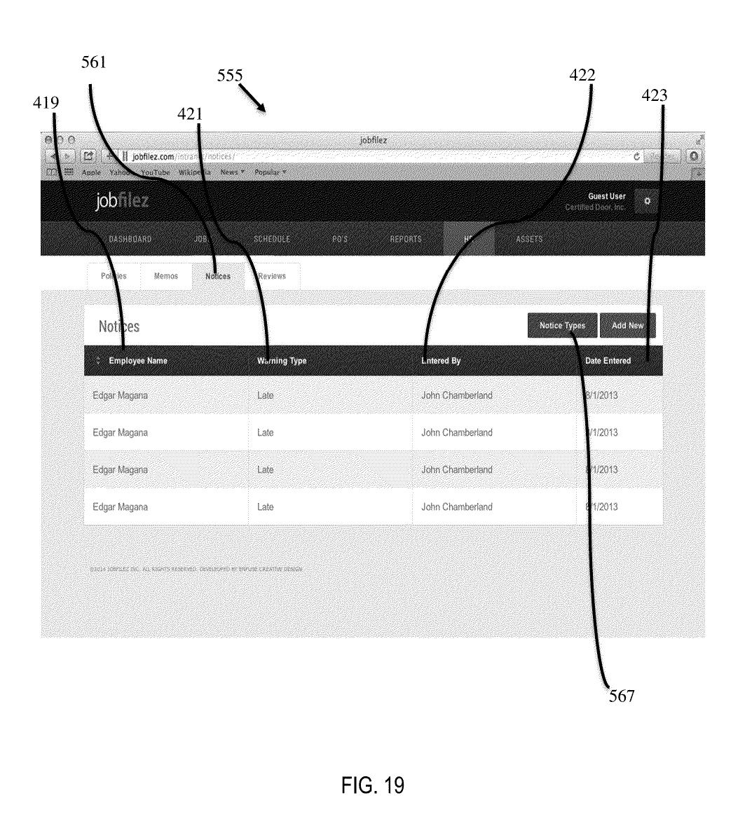

FIG. 19 is a screen shot of one embodiment of the project management method and shows the notices screen. As shown in FIG. 19, one embodiment of the notices screen 555 may comprise: employee names 419, warning types 421, submitters 422, and dates entered 423, and a notice types button 567. The employee names 419, may list one or more names of employees that are subject to the notices. The warning types 421 may indicate the type of warning that is involved. For example, FIG. 19 shows that the warning type may be based on tardiness for being late on the job. The submitters 422 may show who has submitted the notice. The dates entered 423 generally refer to the date and/or time when the notice was submitted by the submitter.

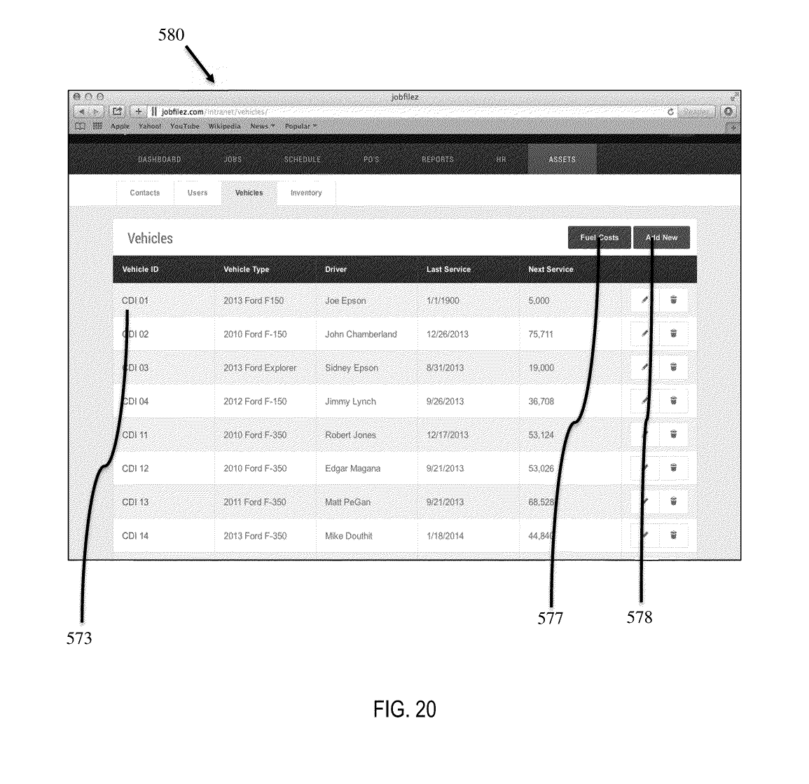

FIG. 20 is a screen shot of one embodiment of the project management method and shows the vehicles screen. The vehicles screen 580 may allow a user and/or administrator to view which company vehicle is assigned to which employee. As shown in FIG. 20, one embodiment of the vehicles screen 580 may comprise: vehicle entries 573, a fuel costs feature 577, and an add new vehicle option 578. The vehicle entries 573 may allow a user to view the details and information on a particular vehicle, such as the year, make, and model. Such information may also include the date of last service, mileage at which the next vehicle serving should occur, the vehicle's current mileage, notes regarding a vehicle, and whether the vehicle is active. The add new vehicle option 578 preferably allows the employer to add another vehicle into the database.

FIG. 20 also shows the fuel costs feature 577. The fuel costs feature 577 may allow employees to easily and quickly enter information relating to their fuel costs, which may assist employers in reimbursement for these costs.

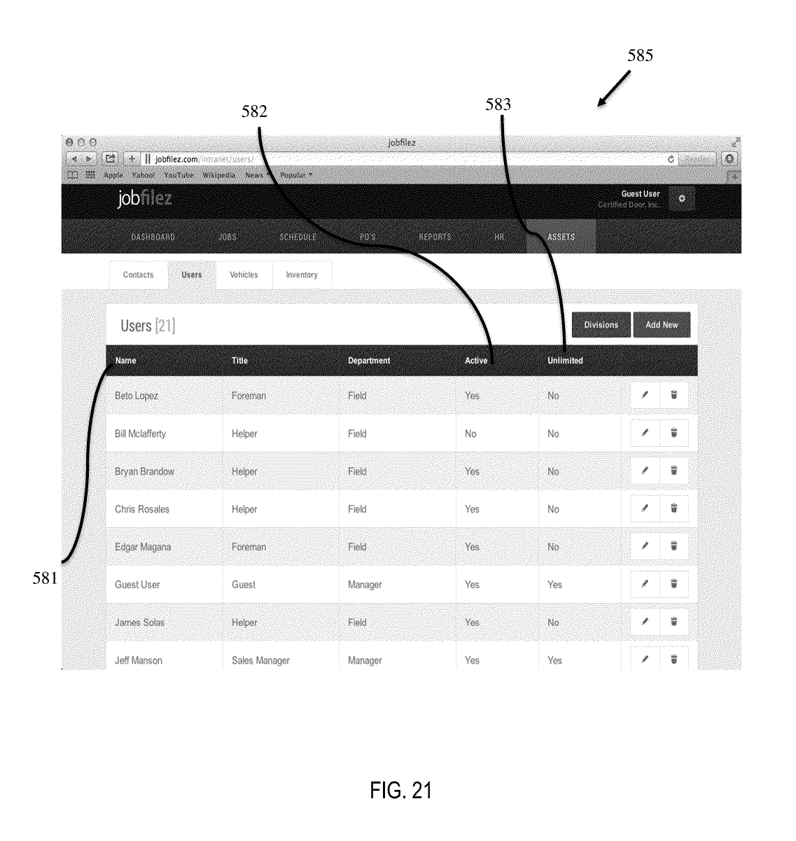

FIG. 21 is a screen shot of one embodiment of the project management method and shows the users screen. As shown in FIG. 21, one embodiment of the users screen 585 may comprise: account user names 581, account status 582, and user limits 583. The users screen 585 may provide administrators with an overview of all account user names 581, which will preferably allow the administrator to view information about each individual user such as the rights and permissions of every account user within the company.

The users screen 585 may also include the account status 582 and user limits 583 for each user. The account status 582 may tell an administrator and/or account users whether a particular employee's account is active or inactive. The user limits 583 may inform an administrator and/or account user whether a particular employee's account is limited or unlimited in terms of rights and permissions for the software of the project management methods and systems. Typically, administrators may have unlimited access and employees may have limited access. However, this may vary according to administrator wishes.

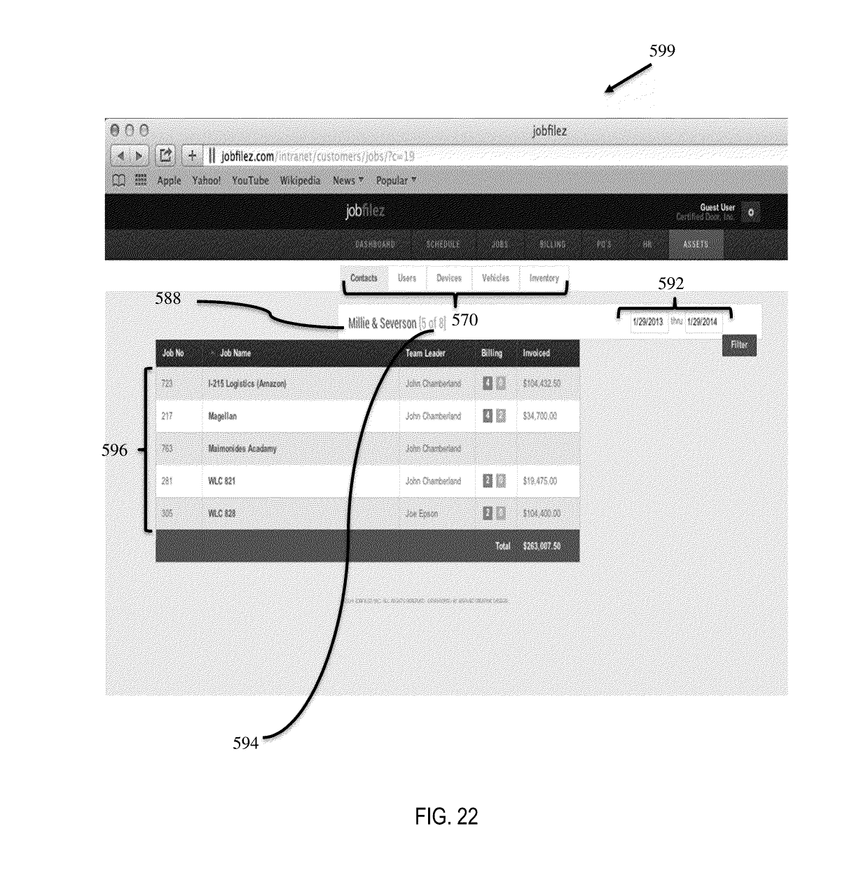

FIG. 22 is a screen shot of one embodiment of the project management method and shows the contacts screen. As shown in FIG. 22, one embodiment of the contacts screen 599 may comprise: a customer name 588, date range 592, client jobs viewing ratio 594, and job entries 596. The date range 592 may allow a user to view client jobs pertaining to duration of a particular time frame and preferably under a particular customer name 588. The client jobs viewing ratio 594 may reflect the number of particular jobs relating to a particular contact or client. The total number of client jobs may include jobs that do not fall into a particular date range 592.

FIG. 22 also shows job-specific information 596. This information may include, without limitation, the job number, title of the job, team leader for a particular job, and billing and invoice details. A user may also be able to select a particular job name in order to navigate to a page with more in-depth information for that particular job.

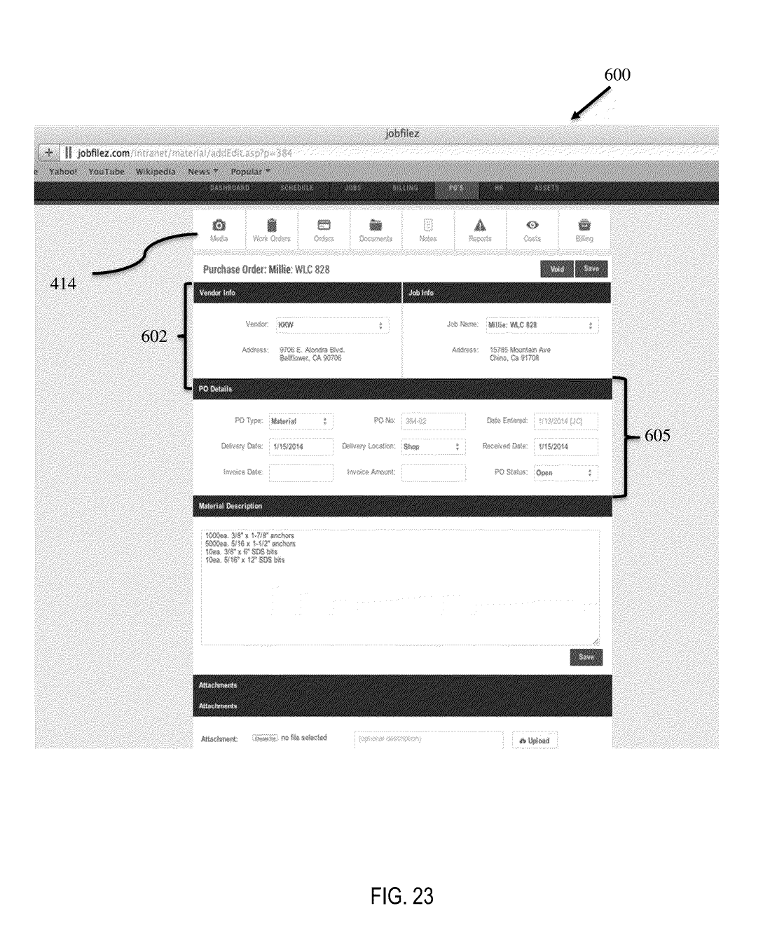

FIG. 23 is a screen shot of one embodiment of the project management method and shows the purchase orders screen. As shown in FIG. 23, one embodiment of the purchase orders screen 600 may comprise: a viewing bar 414, vendor information 602, and purchase order details 605. The viewing bar 414 may appear on any number of screens, as desired, including but not limited to the purchase orders screen 600 and the jobs screen. The purchase orders screen 600 may show vendor information 602, and such information may include, without limitation: the vendor name, address, phone number, email address, and other relevant vendor details. The purchase order details 605 may also comprise the type of purchase—e.g., material or equipment purchase—the delivery date, the invoice date, the purchase order number, the delivery location, the invoice amount, the date the purchase order was entered, the date the purchase order was received, and the status of the purchase order.

The purchase orders screen 600 may also comprise a number of other desired features, such as a material description section, a file attachment section, and a notes section, to name a few.

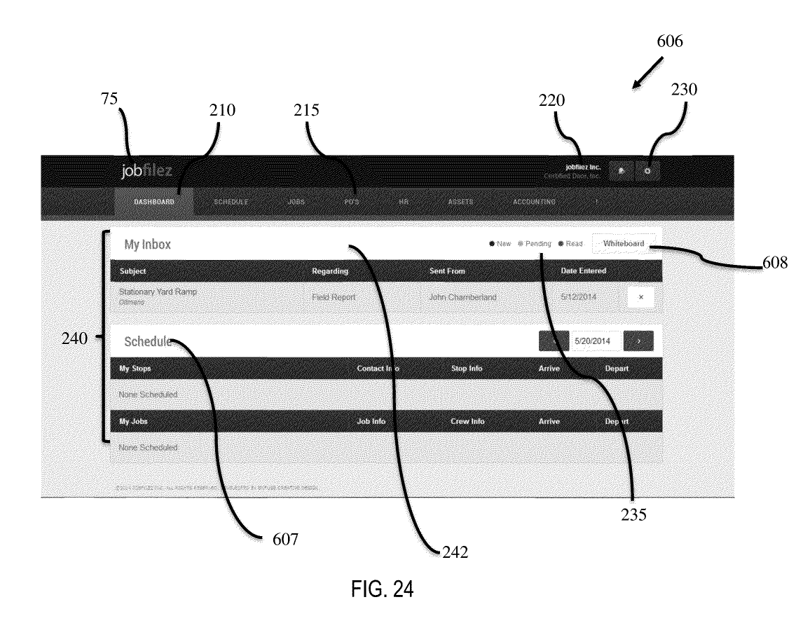

FIG. 24 is a screen shot of another embodiment of the project management method and shows the home screen. As shown in FIG. 24, another embodiment of the home screen 606 may comprise: a logo and/or trademark 75, an active tab 210, inactive tabs 215, a settings icon 230, a color-coded key 235, information tables 240, identifying user data 220, and a whiteboard button 608. As discussed above, a desired tab's panel may be accessed by selecting the desired tab. The active and inactive tabs 210, 215 may comprise features desired by the account user or business owner, such as the following: Dashboard, Jobs, Schedule, PO's, HR, Assets, and Accounting, as seen in the home screen 606. However, the labeling, content, and number of active and inactive tabs 210, 215 may be adjusted according to the preferences of the business administrator's and/or account user.

FIG. 24 also shows that the information tables 240 may comprise a range of graphs or tables on the home screen 606, including, without limitation, an inbox table 242 and a schedule table 607. Additionally, informational tables 240 may be added or removed, in accordance with the preference of the user and/or administrator.

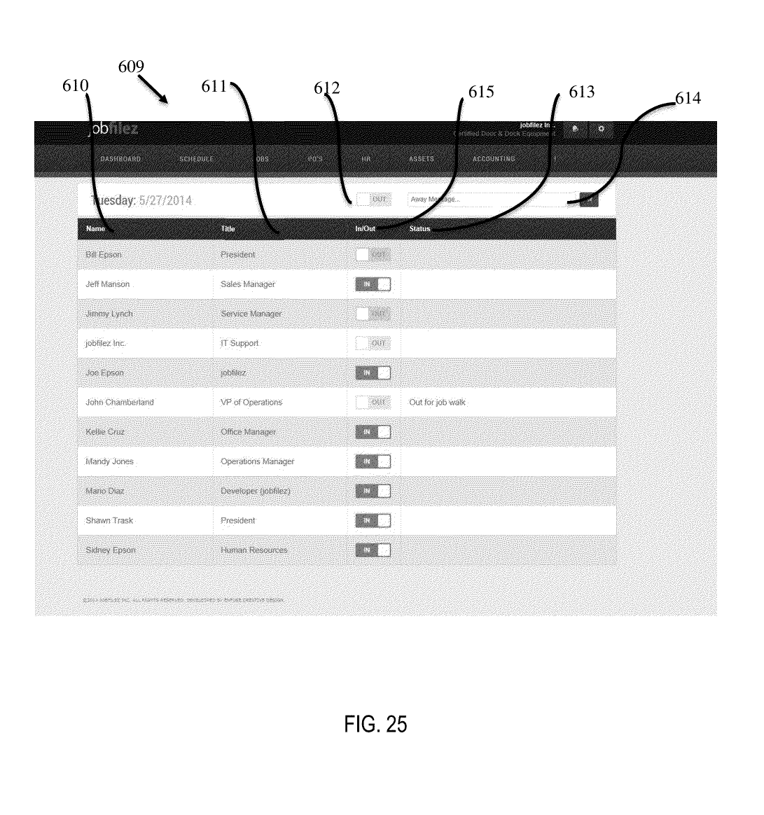

FIG. 25 is a screen shot of another embodiment of the project management method and shows the whiteboard screen. As shown in FIG. 25, another embodiment of the whiteboard screen 609 may comprise: user list 610, job titles 611, occupancy list 615, status messages 613, occupancy status switch 612, and away message text box 614. Users may set their individual status by toggling the status switch 612 to indicate whether the users are in the office. This individual status may then be displayed in the occupancy list 615, which informs administrators or other users whether a particular user is present. Users may also create a message to indicate and/or explain their current assignment in the away message text box 614. In an embodiment, this explanation may then be displayed in the list of user status messages 613.

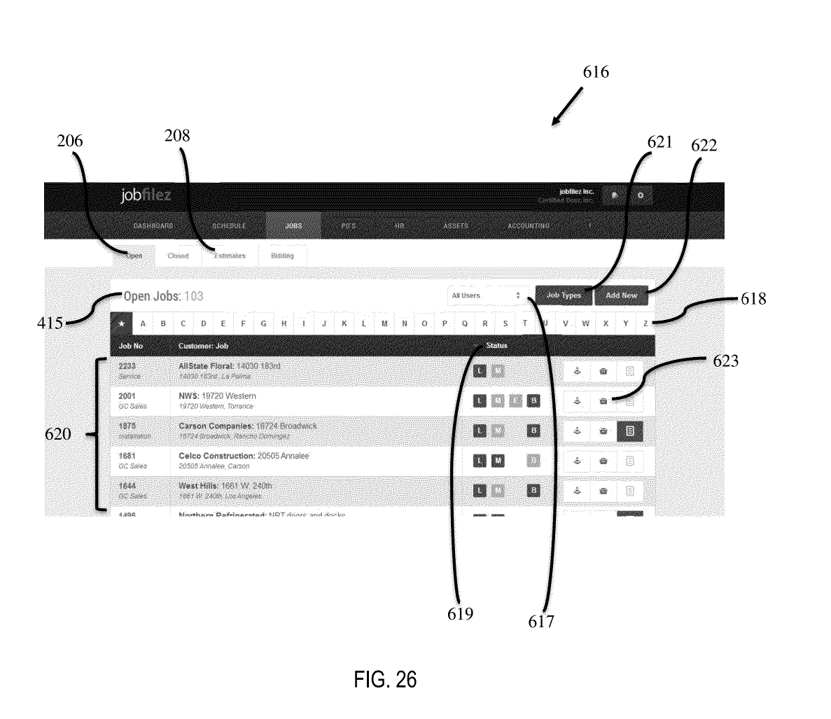

FIG. 26 is a screen shot of another embodiment of the project management method and shows one embodiment of the jobs folder. As shown in FIG. 26, another embodiment of the jobs screen 616 may comprise: an active sub-tab 206, inactive sub-tabs 208, an objective bar 415, general job data 620, status icons 619, job information icons 623, user drop-down selection menu 617, job types button 621, and alphabetical selector list 618. The active sub-tab 206 may be highlighted to distinguish itself from the inactive sub-tabs 208, and may contain a panel of information related to the information found in the objective bar 415. The objective bar 415 may list the objective of the active sub-tab 206, such as obtaining a list of currently open jobs. This list may be further filtered either alphabetically by selecting the first letter of a desired customer name in the alphabetical selector list 618 or by particular user, which can be selected using the drop-down menu 617. The active sub-tab 206 screen may also display the general job data 620, which may comprise: the job number, customer and job name, and job status 619. Within the job status column 619, icons may appear, which generally report various costs-related functions when selected which may include, without limitation, labor costs, material costs, equipment costs, and billing status. A list of job classifications may also be viewed by selecting the job types button 621, and classifications may be added by selecting the “Add New” button 622. Further information, such as billing information, additional jobs performed for the client, and notes for a specific job may be gathered by selecting job information icons 623.

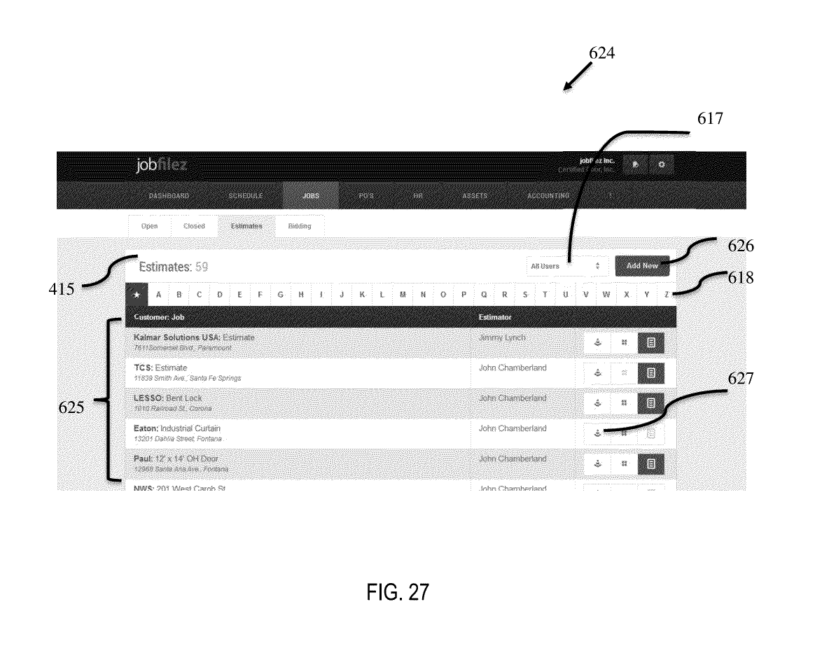

FIG. 27 is a screen shot of another embodiment of the project management method and shows another embodiment of the estimates screen of the jobs folder. As shown in FIG. 27, another embodiment of the estimates screen 624 may comprise: an objective bar 415, general estimate data 625, estimate icons 627, user drop-down selection menu 617, new estimate button 626, and alphabetical selector 618. The objective bar 415 may list the objective of the active sub-tab 206, such as a list of estimates. This list may be further refined either alphabetically by selecting the first letter of a desired customer name in the alphabetical selector list 618 or by the estimator who prepared the estimate, which can be selected using the user drop-down selection menu 617. The estimates screen 624 may display the general estimate data 625, which may comprise: the customer and job name, estimator name, and various estimate icons 627. The estimate icons generally contain information, including, without limitation, pricing information, additional jobs performed for the client, and notes for a specific job can be gathered by clicking on the various icons 623. New estimates can be added by selecting the new estimate button 626.

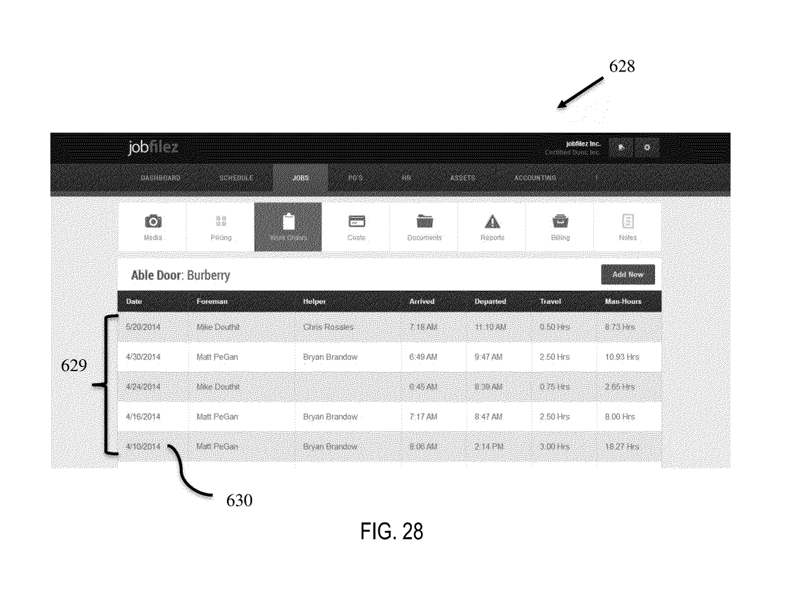

FIG. 28 is a screen shot of another embodiment of the project management method and shows the work orders screen of the jobs folder. As shown in FIG. 28, another embodiment of the work orders screen 628 may comprise: general job data 629. The general job data 629 may comprise information such as the date of the work order, the foreman for the work order, presence of a helper, the time the employee arrive at and departed from the job, the travel time required, and the total for the specific task.

As shown in FIG. 28, the date 630 may comprise a link that, when selected, provides additional information regarding a particular work order. This information may also comprise other information such as customer information and additional job information.

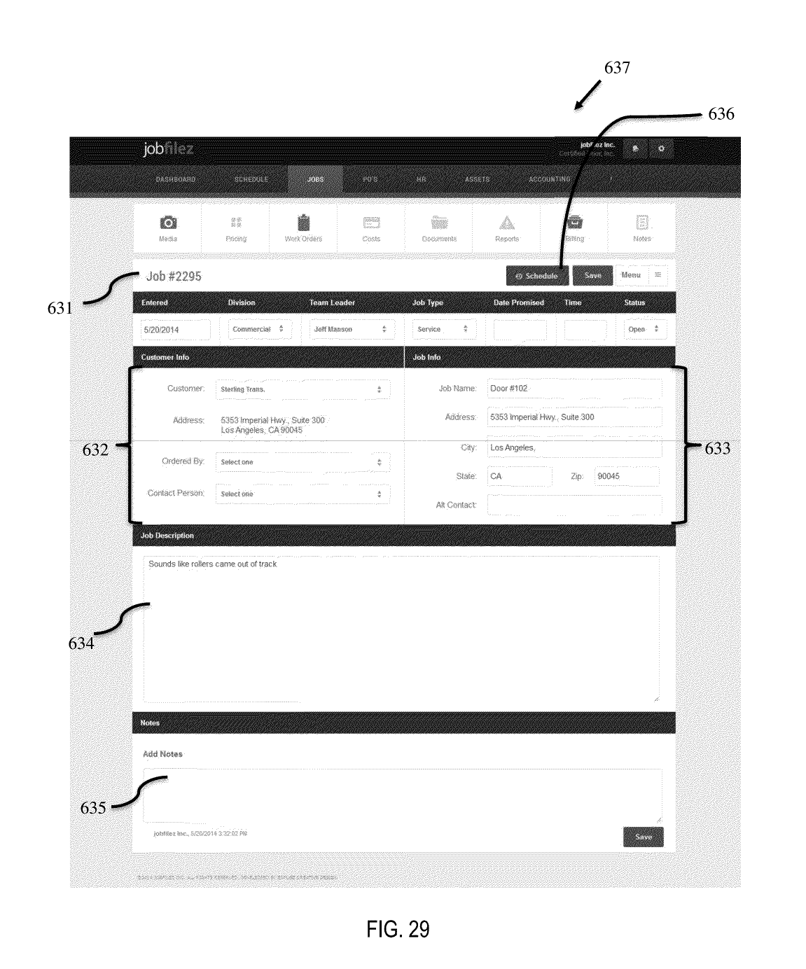

FIG. 29 is a screen shot of another embodiment of the project management method and shows the job details screen. As shown in FIG. 29, another embodiment of the jobs specifics screen 637 may comprise: a job number 631, customer information 632, basic job information 633, job description 634, job notes 635, and a schedule button 636. The customer information 632 may show, among other things, customer-specific information such as the customer's name, address, and person of contact. The basic job information 633 may comprise information such as the job name and address. The job description 634 may describe what the client is requesting. The schedule button 636 may allow a user to view and schedule additional work, if needed.

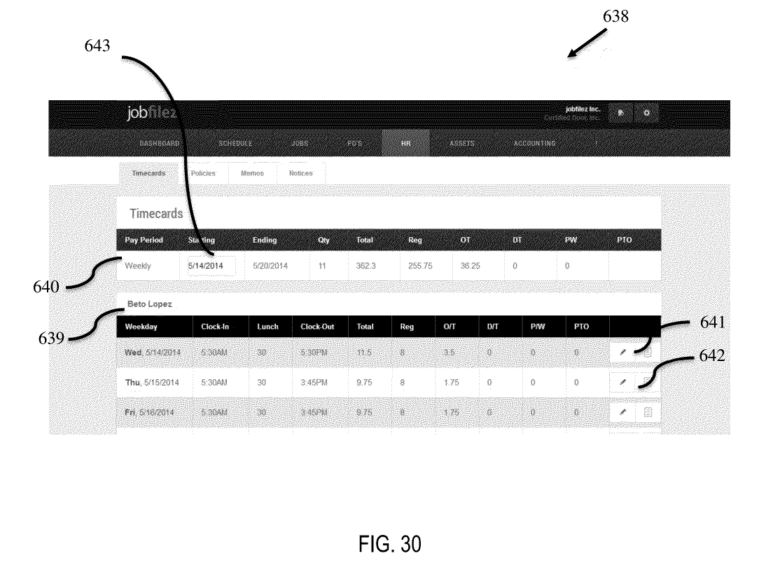

FIG. 30 is a screen shot of another embodiment of the project management method and shows the timecard screen. As shown in FIG. 30, another embodiment of the timecard screen 638 may comprise: name of the employee 639, time period 640, edit icons 641, and notes icons 642. The time period 640 generally shows the duration of the time sheet or time card and may be edited by selecting the starting date box 643 and choosing another date from the calendar drop down menu. Individual timecards may be altered by selecting the edit icon 641. Notes pertaining to a timecard may be added by selecting the notes icon 643.

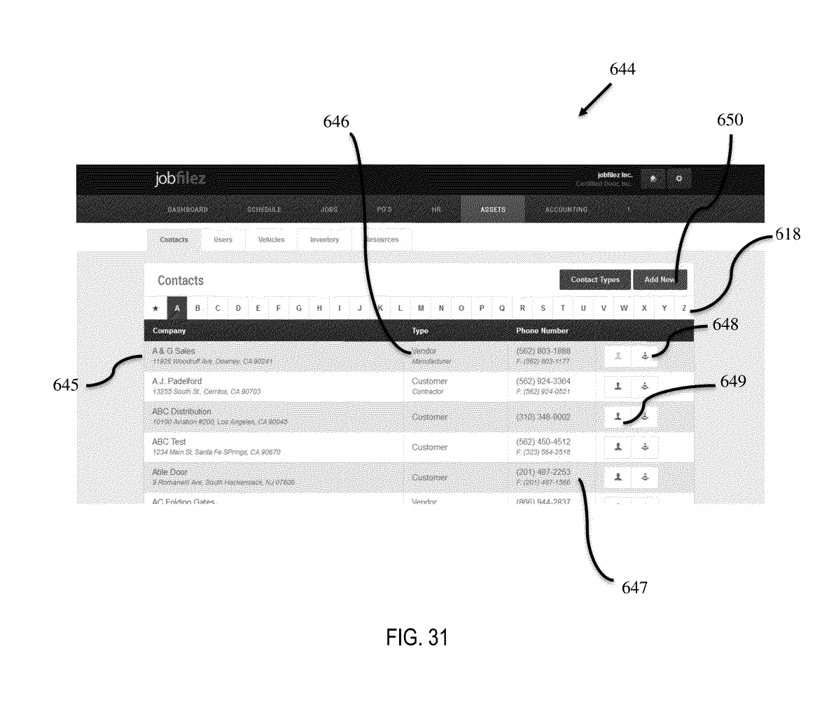

FIG. 31 is a screen shot of another embodiment of the project management method and shows the contacts screen. As shown in FIG. 30, another embodiment of the contacts screen 644 may comprise: company entries 645, contact type 646, phone numbers 647, alphabetical selector 618, job information icons 648, and point of contact icons 649. This list can be further refined either alphabetically by selecting the first letter of a desired customer name in the alphabetical selector list 618. Additionally, a user may add a new contact type by selecting the “Add New” button 650 and supplying requested information. A user may view a specific point of contact's information by selecting the point of contact icon 649 under the corresponding company.

FIG. 31 also shows a job history for a company by selecting the job information icon 648. This information may comprise the job number and name, date of job entry, and billing amount. A user may also be able to click or tap on a particular job name in order to navigate to a page with more in-depth information for that particular job. Furthermore, the job history of a company can be filtered by selecting relevant dates.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A project management method, the computer-implemented steps comprising:
providing a project management software platform running on a server;
wherein said project management software platform is accessible by one or more electronic data processing units;
wherein said one or more electronic data processing units each have at least one display and are configured to access said project management software platform;
wherein said project management software platform comprises a plurality of project icons;
wherein said plurality of project icons are configured for linking a plurality of database locations for storing one or more files and a plurality of text information associated with one or more projects;
allowing access on an administrative basis to said project management software platform via at least one of said one or more electronic data processing units in order to set up one or more projects;
storing a plurality of user accounts on said project management software platform;
allowing a user to set up said one or more projects via said project management software platform;
wherein said setting-up step comprises the steps of: receiving which of said plurality of user accounts will be configured to access each of said one or more projects being set up; and receiving one or more of said plurality of project icons to be associated with each of said one or more projects;
receiving by said project management software platform of a user login information through at least one of said one or more electronic data processing units;
presenting to said logged-in user said projects to which said logged-in user has access;
allowing said logged-in user to upload said one or more files associated with said one or more projects to at least one of said plurality of project icons within at least one of said one or more projects;
wherein said one or more uploaded files are organized within said plurality of project icons such that said project management software platform allows at least one second user to find and view said one or more uploaded files with a minimal waste of time; and
allowing at least one second user to view said one or more uploaded files on said at least one display with minimal time wasted in finding said one or more uploaded files.

2. The method according to claim 1, wherein said setting-up steps further comprise the step of: determining what type of access each of said selected user accounts has.

3. The method according to claim 1, wherein said project management software platform is accessible through the Internet.

4. The method according to claim 2, wherein said project management software platform collects a username and a password of said user and said at least one second user.

5. The method according to claim 4, wherein said plurality of project icons are selected from the group of project icons consisting of: media; field reports; work orders; office documents; notes; reports; costs; billing; subcontractor; and daily logs.

6. The method according to claim 5, wherein said one or more uploaded files are comprised of video and photo files that are displayed as thumbnails within said plurality of project icons.

7. The method according to claim 6, further comprising the steps of:
wherein one or more of said plurality of project icons are configured to accept entry of a plurality of text information;
receiving a plurality of text information within at least one of said plurality of project icons.

8. The method according to claim 7, wherein said plurality of project icons are comprised of a visual indicator which is configured to notify that at least one of said one or more files have been uploaded.

9. The method according to claim 8, wherein said plurality of project icons comprises a visual indicator which is configured to notify that text information has been entered with at least one of said plurality of project icons.

10. The method according to claim 9, wherein said project management software platform is configured to organize and track: scheduling; purchase orders; human resources; and
assets.

11. A project management method, the computer-implemented steps comprising:
providing a project management software platform running on a server;
wherein said project management software platform is accessible by one or more electronic data processing units;
wherein said one or more electronic data processing units each have at least one display and are configured to access said project management software platform;
wherein said project management software platform comprises a plurality of project icons;
wherein said plurality of project icons configured for linking a plurality of database locations for storing one or more files associated with one or more projects;
allowing access on an administrative basis to said project management software platform via at least one of said one or more electronic data processing units in order to set up one or more projects;
allowing a user to set-up said one or more projects via said project management software platform;
wherein said setting-up step comprises the steps of: receiving which of a plurality of users may access each of said one or more projects; storing what type of access that each of said selected users may have; and receiving one or more of said plurality of project icons to be associated with each of said one or more projects;
receiving by said project management software platform a user login information through at least one of said one or more electronic data processing units;
presenting to said logged-in user said projects to which said logged-in user has access;
receiving by said plurality of project icons within at least one of said one or more projects said one or more files associated with said one or more projects;
wherein said one or more uploaded files are organized within said plurality of project icons such that said project management software platform allows at least one second user to find and view said one or more uploaded files with a minimal waste of time; and
viewing by at least one second user said one or more uploaded files on said at least one display with minimal time wasted in finding said one or more uploaded files.

12. The method according to claim 11, wherein said project management software platform is accessible through the Internet.

13. The method according to claim 11, wherein said project management software platform collects a username and a password of said user.

14. The method according to claim 11, wherein said plurality of project icons are selected from the group of project icons consisting of: media; field reports; work orders; office documents; notes; reports; costs; billing; subcontractor; and daily logs.

15. The method according to claim 11, wherein said one or more uploaded files are comprised of video and photo files that are displayed as thumbnails within said plurality of project icons.

16. The method according to claim 11, further comprising the steps of:
wherein one or more of said plurality of project icons are configured to accept entry of a plurality of text information;
receiving a plurality of text information within at least one of said plurality of project icons.

17. The method according to claim 16, wherein said plurality of project icons are comprised of a visual indicator which is configured to notify that at least one of said one or more files have been uploaded.

18. The method according to claim 17, wherein said plurality of project icons are comprised of a visual indicator which is configured to notify that text information has been entered with at least one of said plurality of project icons.

19. The method according to claim 11, wherein said project management software platform is configured to organize and track: scheduling; purchase orders; human resources; and
assets.

20. A project management method, the computer-implemented steps comprising:
providing a project management software platform running on a server;
providing one or more electronic data processing units;
wherein said one or more electronic data processing units each have at least one display and can access said project management software platform;
wherein said project management software platform is comprised of a plurality of project icons;
wherein said plurality of project icons are used as a plurality of database locations to store one or more files associated with one or more projects;
allowing access on an administrative basis to said project management software platform via at least one of said one or more electronic data processing units in order to set up one or more projects;
allowing a user to set-up said one or more projects via said project management software platform;
wherein said setting-up step comprises the steps of: receiving which of a plurality of users may access each of said one or more projects; storing what type of access each of said selected users may have; and receiving one or more of said plurality of project icons to be associated with each of said one or more projects;
receiving by said project management software platform of a user login information through at least one of said one or more electronic data processing units;
presenting to said logged-in user said projects to which said logged-in user has access;
receiving by said plurality of project icons within at least one of said one or more projects said one or more files associated with said one or more projects;
wherein said one or more uploaded files are organized within said plurality of project icons such that said project management software platform allows at least one second user to find and view said one or more uploaded files with a minimal waste of time;
viewing by at least one second user said one or more uploaded files on said at least one display with minimal time wasted in finding said one or more uploaded files;
wherein said project management software platform is accessible through the Internet;
wherein said said project management software platform collects username and a password of said user;
wherein said plurality of project icons are selected from the group of project icons consisting of: media; field reports; work orders; office documents; notes; reports; costs; billing; subcontractor; and daily logs;
wherein said one or more uploaded files are comprised of video and photo files that are displayed as thumbnails within said plurality of project icons;
wherein one or more of said plurality of project icons are configured to accept entry of a plurality of text information;
receiving a plurality of text information within at least one of said plurality of project icons;
wherein said plurality of project icons are comprised of a visual indicator which is configured to notify that at least one of said one or more files have been uploaded;
wherein said visual indicator is configured to notify that text information has been entered with at least one of said plurality of project icons; and
wherein said project management software platform is configured to organize and track: scheduling; purchase orders; human resources; and assets.
